(19) United States
(12) Patent Application Publication
(10) Pub. No.: US 2026/0109109 A1
(43) Pub. Date: Apr. 23, 2026

(54) ADDITIVE MANUFACTURING GUIDE

(71) Applicants: DOW GLOBAL TECHNOLOGIES LLC, Midland, MI (US); DOW SILICONES CORPORATION, Midland, MI (US); THE REGENTS OF THE UNIVERSITY OF MICHIGAN, Ann Arbor, MI (US)

(72) Inventors: James LORENZ, Ann Arbor, MI (US); William VAN DEN BOGERT, Ann Arbor, MI (US); Albert SHIH, Ann Arbor, MI (US); Nima FAZELI, Ann Arbor, MI (US); Bizhong ZHU, Midland, MI (US); Stanley YEE, Midland, MI (US); Kurt A. KOPPI, Midland, MI (US)

(21) Appl. No.: 19/362,893

(22) Filed: Oct. 20, 2025

Related U.S. Application Data
(60) Provisional application No. 63/710,975, filed on Oct. 23, 2024.

(51) Int. Cl. B29C 64/209; B29C 48/02; B29C 48/30; B29C 48/92; B29C 64/118; B29C 64/393; B29K 83/00; B33Y 10/00; B33Y 40/00; B33Y 50/02

(52) U.S. Cl. CPC B29C 64/209; B29C 48/02; B29C 48/302; B29C 48/92; B29C 64/118; B29C 64/393; B33Y 10/00; B33Y 40/00; B33Y 50/02; B29C 2948/92047; B29C 2948/92409; B29C 2948/92619; B29C 2948/92904; B29K 2083/00

(57) ABSTRACT

An additive manufacturing guide for variable size additive manufacturing is provided. The additive manufacturing guide includes an actuator movable between a maximum flow position and a minimum flow position. The additive manufacturing guide also includes an adjustable port defining a variable area outlet aperture. The actuator is configured to deform the adjustable port to selectively resize the variable area outlet aperture. The maximum flow position corresponds to a maximum area of the variable area outlet aperture and the minimum flow position corresponds to a minimum area of the variable area outlet aperture. An additive manufacturing system including the additive manufacturing guide is also provided. A method of additive manufacturing with variable bead sizes using the additive manufacturing guide is further provided.

### CROSS REFERENCE TO RELATED APPLICATIONS

The present application claims the benefit of U.S. Provisional Patent Application No. 63/710,975, filed Oct. 23, 2024, the disclosure of which is incorporated herein by reference.

### FIELD OF THE INVENTION

The present disclosure relates generally to a feedstock guide for additive manufacturing and associated systems and methods, more specifically, to an additive manufacturing guide for variable bead width additive manufacturing.

### BACKGROUND

Additive manufacturing, or 3D printing, is a method where objects are built or printed layer by layer from digital models. Silicones, known for their flexibility, durability, and resistance to extreme temperatures and chemicals, are increasingly used in additive manufacturing due to their unique properties. By utilizing specialized silicone-based inks or resins, this process allows for the creation of complex, customizable parts that exhibit excellent performance in demanding environments. This capability is particularly valuable in industries such as aerospace, automotive, and healthcare, where the combination of high precision and material resilience can lead to innovations in product design and functionality. The development of additive manufacturing techniques for silicones not only expands the range of applications but also enhances the potential for creating tailored solutions that meet specific operational requirements.

One known method of additive manufacturing is the direct Ink Write (DIW) method. The DIW method is a process in which liquid material is extruded through a rigid nozzle in a continuous bead. As the nozzle deposits material, it traces the print bead along a 2D path, covering a flat area with material in a specific pattern. The geometry of the deposited print bead is determined by the geometry of the nozzle from which the material flows; because conventional extrusion nozzles have a circular orifice at the tip, the print bead has a circular cross-section. Further, because the nozzle orifice constricts the flow of material at the tip, the inner diameter of the nozzle orifice is the critical feature that determines the diameter of the print bead. This bead diameter is used to algorithmically predetermine the path of an entire layer of a 3D print. The DIW machine then executes each layer's 2D path in a layer-by-layer fashion for the entire print. The use of a simple fixed nozzle tip in conventional DIW manufacturing only allows for a single nozzle size, so users of DIW 3D printing must select the proper width of nozzle to install before the print begins, which determines the size of bead that the printer will use. Regardless of printed part geometry, the print bead must remain at the preselected size for the entire duration of the print.

### BRIEF SUMMARY

An additive manufacturing guide for variable size additive manufacturing is provided. The additive manufacturing guide comprises an actuator. The actuator is movable between a maximum flow position and a minimum flow position. The additive manufacturing guide also comprises an adjustable port defining a variable area outlet aperture. The actuator is configured to deform the adjustable port to selectively resize the variable area outlet aperture. The maximum flow position corresponds to a maximum area of the variable area outlet aperture and the minimum flow position corresponds to a minimum area of the variable area outlet aperture.

One embodiment of the additive manufacturing guide is also provided. In this embodiment, the actuator is a pneumatic radial actuator comprising a toric housing and a toric balloon disposed within the toric housing. Inflation or deflation of the toric ballon displaces the toric housing and increases or decreases a volume of the toric housing. The adjustable port is a nozzle tip comprising a conical elastomeric body embedded with a network of metal rods. The toric housing of the pneumatic radial actuator is disposed about the conical elastomer body of the nozzle tip such that inflation of the toric ballon compresses the network of metal rods and shrinks the variable area outlet aperture. Likewise deflation of the toric ballon relaxes the network of metal rods and enlarges the variable area outlet aperture. An unsymmetric network of metal rods, together with the toric ballon, will also render change in the nozzle shape in addition to its size.

Another embodiment of the additive manufacturing guide is further provided. In this embodiment, the actuator is a linear actuator coupled to a membrane support. The membrane support defines a membrane aperture. The adjustable port is a deformable membrane coupled to the membrane support such that the membrane aperture and the variable area outlet aperture are aligned.

An additive manufacturing system comprising the additive manufacturing guide is also provided.

A method of additive manufacturing with variable bead sizes using the additive manufacturing guide is also provided. The method comprises the step of extruding a printing material out of the variable area outlet aperture defining a first area to form a first bead path having a first bead path width. A toric ballon is inflated or deflated to compress or relax the network of metal rods of a nozzle tip and shrink or enlarge the variable area outlet to define a second area. The printing material is extruded out of the variable area outlet defining the second area to form a second bead path having a second bead path width. The second area is smaller or larger than the first area, can have a different shape if desired, and the second bead path width is smaller or larger than the first bead path width.

### DESCRIPTION OF THE DRAWINGS

Various advantages and aspects of this disclosure may be understood in view of the following detailed description when considered in connection with the accompanying drawings, wherein:

FIG. 1 shows a perspective view of an additive manufacturing guide according to one first embodiment of the invention;

FIG. 2 shows a perspective view of an additive manufacturing guide according to another second embodiment of the invention;

FIG. 3 shows an exploded perspective view of the additive manufacturing guide according to the first embodiment of the invention;

FIG. 4 shows zoomed in perspective view of the additive manufacturing guide according to the first embodiment of the invention;

FIG. 5 shows a side view of the additive manufacturing guide according to the first embodiment of the invention;

FIG. 6 shows a zoomed in perspective view of the additive manufacturing guide according to the second embodiment of the invention; and

FIG. 7 shows a zoomed in side view of a deformable membrane resting in a relaxed state and deformed about a shaft in a stretched state.

### DETAILED DESCRIPTION

An additive manufacturing guide for variable size additive manufacturing is provided herein. As will be understood from the description herein, the inventive additive manufacturing guide provides superior real-time, dynamic modification of the diameter of printed bead size. Specifically, the additive manufacturing guide allows for several advantages over conventional additive manufacturing nozzles including allowing for higher speed prints, finer bead precision, and unique printing geometries unattainable by conventional additive manufacturing nozzles. The dynamic modification of the diameter of the printed bead size allows for selectively wider bead paths for infill areas, where fine resolution is not desired, to facilitate higher printing speeds. The dynamic modification further allows for a narrower bead path to accommodate fine contours and thin geometries. In some embodiments, the additive manufacturing guide further allows for a zero-bead thickness path or non-extrusion travel path. This allows for the generation of printing material free “islands” within an individual two-dimensionally printed layer. This feature can be used to create complex geometries and custom production parts (e.g., fillings, gaskets) for architecture and art industries as well as orthodontics and prosthetics in the medical industry. These advantages are all attainable without the substitution of the additive manufacturing guide with a different diameter additive manufacturing guide mid print.

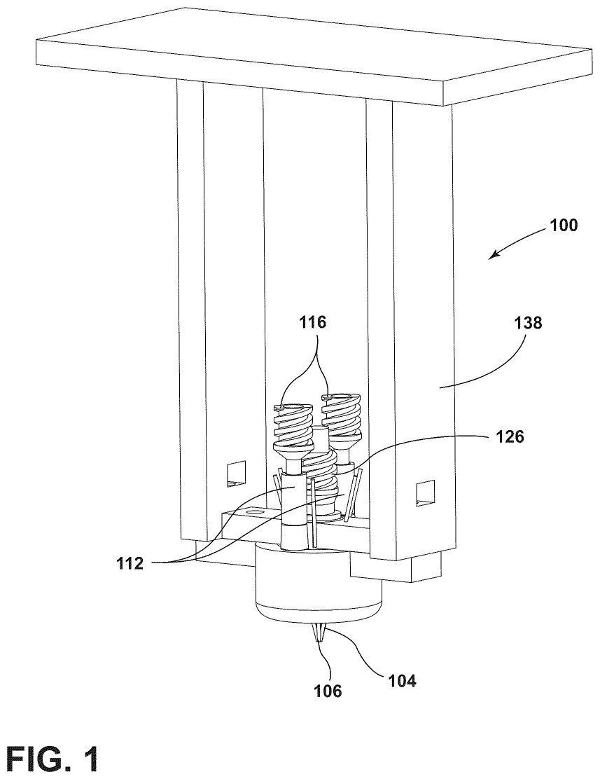

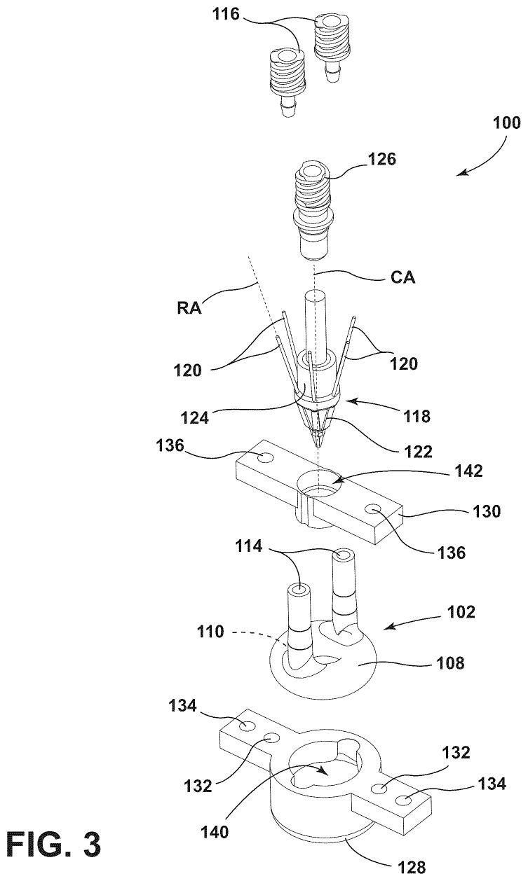

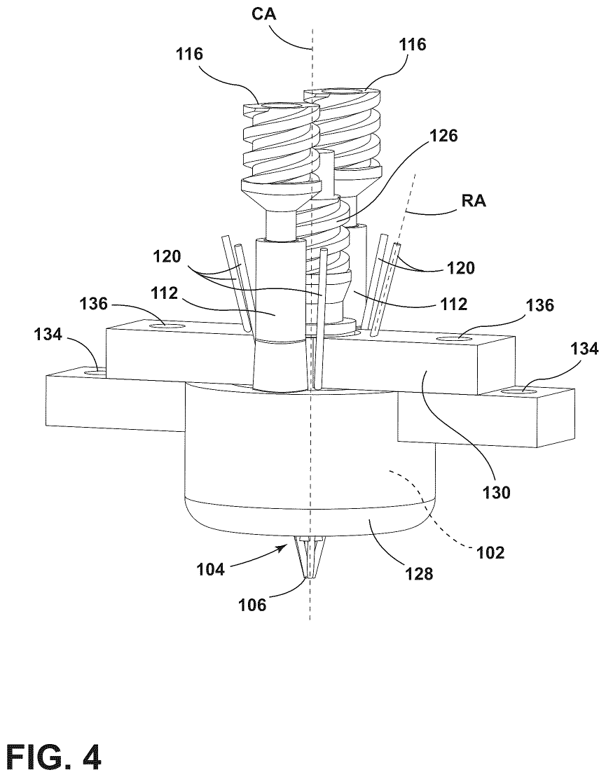

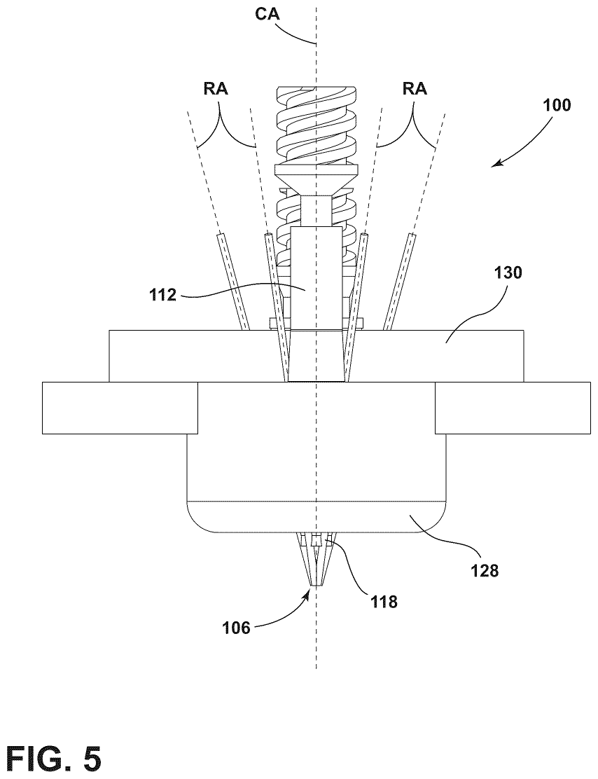

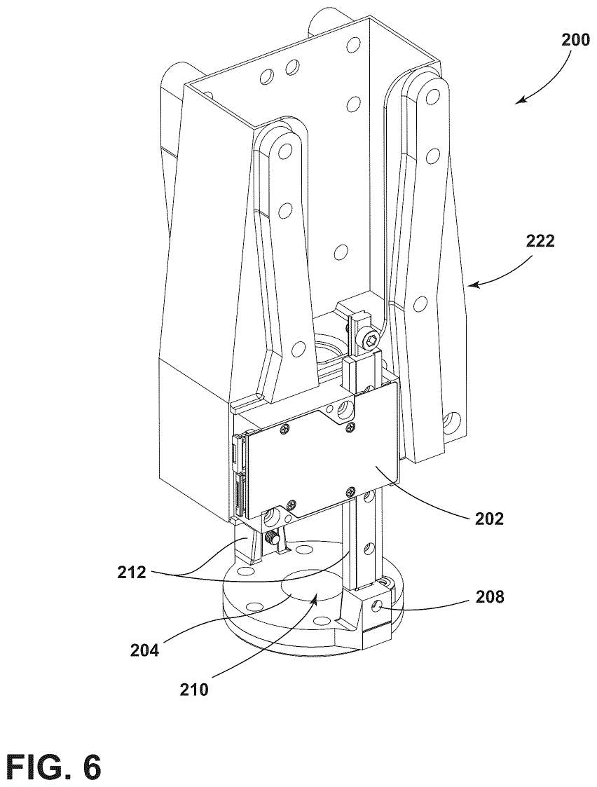

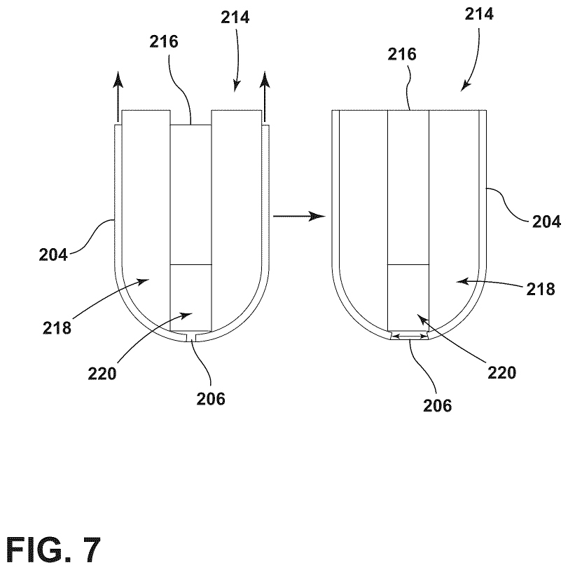

With reference to FIGS. 1-7, wherein like numerals indicate corresponding parts throughout the several views, the additive manufacturing guide is illustrated and generally designated at 100 or 200, depending on the embodiment. Certain features of the additive manufacturing guide are functional, but can be implemented in different aesthetic configurations. The additive manufacturing guide 100, 200 generally includes an actuator 102, 202, and an adjustable port 104, 204.

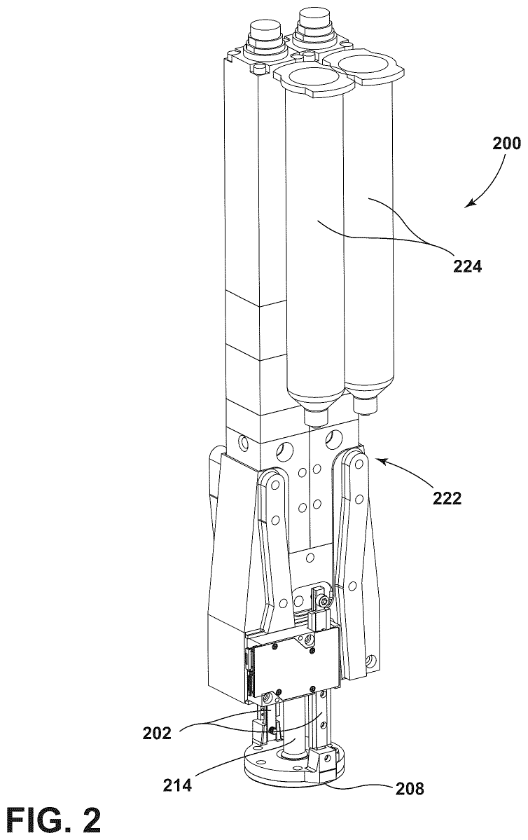

FIGS. 1 and 2 depict the additive manufacturing guide 100, 200 according to two distinct embodiments. The additive manufacturing guide 100, 200 comprises an actuator 102, 202 between a maximum flow position and a minimum flow position. The additive manufacturing guide 100, 200 also comprises an adjustable port 104, 204 defining a variable outlet aperture 106, 206. The actuator 102, 202 is configured to deform the adjustable port 104, 204 to selectively resize the variable outlet aperture 106, 206. The maximum flow position of the actuator 102, 202 corresponds to a maximum area of the variable area outlet aperture 106, 206, while the minimum flow position corresponds to a minimum area of the variable area outlet aperture 106, 206. It will be appreciated that during use of the additive manufacturing guide the maximum area will likewise correspond to a maximum bead width of a printed material, while the minimum area will correspond to a minimum bead width of the printed material. Generally, the variable outlet aperture 106, 206 defines a circular or substantially circular cross-section, but alternative geometry cross-sections are also envisioned. In certain embodiments, the minimum flow position corresponds to a closed variable area outlet aperture 106, 206 having a minimum area of zero (i.e., the variable area outlet aperture 106, 206 does not allow for any printed material to pass through the closed variable area outlet aperture 106, 206).

Referring now to FIGS. 1 and 3-5, in certain embodiments, the actuator 102, 202 of the additive manufacturing guide 100 is a pneumatic radial actuator 102. The pneumatic radial actuator 102 comprises a toric housing 108 and a toric ballon 110. The toric ballon 110 is disposed within the toric housing 108. The toric ballon 110 is inflatable with a fluid (e.g., air, inert gas, water) such that inflation or deflation of the toric ballon 110 displaces the toric housing 108 and increases or decreases a volume of the toric housing 108. The toric housing 108 and/or toric balloon 108 may comprise one or more (e.g., two) fluid port arms 112, with each fluid port arm defining a fluid port 114. Each fluid port arm 112 is couplable with a fluid nozzle 116. The fluid nozzle 116 is generally connected to a fluid source (not shown), and acts as a fluid outlet such that a fluid is displaceable from the fluid source through the fluid nozzle 116 through the fluid port(s) 114 and fluid port arm(s) 112 into the toric ballon 110 such that the toric ballon 110 is inflated. The toric ballon 110 may deflate by displacing the fluid out of the toric ballon 110. In some embodiments, the toric ballon 110 deflates by displacing the fluid from the toric ballon 110 through the fluid port arm(s) 112 out of the fluid port(s) 114 and fluid nozzle 116 to the fluid source or a fluid exit (not shown). The material of the toric housing 108 and the toric ballon 110 are not particularly limited, and the material of the toric housing 108 may be any material deformable by fluid pressure of the fluid. Likewise, the material of the toric housing 108 may be any material deformable by the pressure exerted by the toric balloon 110. In some embodiments the toric housing 108 and toric balloon 110 comprise an elastomeric polymer.

The term “deformable” as used in the context of the deformable elements described herein is meant in the conventional sense, i.e., to describe an ability to be re-shaped (i.e., deformed) upon application of a force (e.g. a deformation force). In this sense, the deformable elements are characterized by a relatively low modulus as compared with the forces applied to it during the printing process, and an ability to change shape and/or size due to application of the deformation force, which may comprise a tensile (e.g. pulling, dragging) force, a compressive (e.g. pushing) force, a sheer force, a torsion (e.g. twisting, bending) force, or combinations thereof. As such, the deformable elements may also be colloquially understood in the AM art as “soft” and/or “flexible” elements, as will be best understood in view of the description and examples of the deformable substrate and the substrate composition herein.

The adjustable port 104, 204 may be a nozzle tip 104. The nozzle tip 104 comprises a conical elastomeric body 118 embedded with a network of metal rods 120. The elastomeric body 118 may comprise an outlet cone 122 and a cylindrical inlet 124. Generally, the cylindrical inlet 124 is configured to couple with a feedstock nozzle 126 and the outlet cone 122 defines the variable outlet aperture 106. In certain embodiments, the network of metal rods 120 is embedded in the cylindrical inlet 124.

Each metal rod 120 defines a rod axis RA and the network of metal rods 120 may be symmetrically or unsymmetrically disposed about a central axis CA. Generally, each rod axis RA defines a non-right angle, alternatively acute angle, or alternatively obtuse angle, with the central axis CA. The number of metal rods 120 is not particularly limited, and may be any suitable even, or alternatively odd, number of rods 120 (e.g., six rods). In certain embodiments, each metal rod 120 terminates proximate or at the variable area outlet aperture 106. The material of the elastomeric body 118 and metal rods 120 are not particularly limited, and may be any material suitable for performance of their respective functions. The elastomeric body 118 comprises a material deformable by the displacement of the toric housing 108. In certain embodiments, the elastomeric body 118 comprises an elastomeric polymer. The metal rods 120 generally comprise a metal or metal alloy (e.g., steel, iron, aluminum). However, the metal rods 120 are not so limited, and may comprise, alternatively consist of, a rigid polymer or composite (i.e., the metal rods 120 need not necessarily comprise metal). In embodiments where the rods 120 are unsymmetrically disposed, a change in the toric ballon 110 pressure alter both the area and shape of the variable outlet aperture 106.

Generally, the toric housing 108 is seated within a radial actuator seat 128. The nozzle tip 104 may be disposed within a nozzle seat 130. The radial actuator seat 128 may define one or more (e.g., two) radial actuator seat fastening apertures 132. The radial actuator seat 128 may further define one or more (e.g., two) mount fastening apertures 134. In some embodiments, the nozzle seat 130 defines one or more (e.g., two) nozzle seat fastening apertures 136. The radial actuator seat fastening aperture(s) 132 and the nozzle seating fastening aperture(s) 136 are sized and configured such that fastener(s) (not shown) may be disposed within both the radial actuator seat fastening aperture(s) 132 and the nozzle seating fastening aperture(s) 136, thereby retaining the radial actuator seat 128 and the nozzle seat 130 together. Generally, the fastener is a screw, but the fastener is not so limited and alternative fasteners including nails, bolts, pegs, rods, tapes, glues, and other fasteners may be used.

The radial actuator seat 128 defines a toric chamber 140 sized and configured to retain the toric housing 108. Likewise, the nozzle seat 130 defines a nozzle aperture 142 configured to retain the nozzle tip 104, or the outlet cone 122, such that a portion of the outlet cone 122 is disposed outside of the nozzle aperture 142. The toric housing 108 of the pneumatic radial actuator 102 is disposed about the elastomer body 118, or the outlet cone 122 of the elastomer body 118. Inflation of the toric ballon 110 compresses the network of metal rods 120 and shrinks the variable area outlet aperture 106. Similarly, deflation of the toric ballon 110 relaxes the network of metal rods 120 and enlarges the variable area outlet aperture 106.

In some embodiments, the additive manufacturing guide 100 further comprises a deformation sensor 144. The deformation sensor 144 comprises a series of electrically conductive wire coil disposed about or around an outer surface of the nozzle tip 104. The wire coil generates inductance if charged with an electric current, which generates a magnetic field. The strength of the magnetic field is measurable via magnetic field sensors mounted proximate the additive manufacturing guide 100. If the nozzle tip 104 expands or contracts in response to the inflation or deflation of the toric ballon 110 the inductance of the wire coil changes, which alters the strength of the magnetic field. This change in magnetic field strength is measured and correlated with the area of the variable area outlet aperture 106 to determine the expansion and contraction of the variable area outlet aperture 106.

Referring now to FIGS. 2, 6, and 7, in certain embodiments, the actuator 102, 202 of the additive manufacturing guide 200 is a linear actuator 202. Linear actuators 202 generally are devices that convert rotational motion into linear motion, allowing for precise control of movement along a straight line. The linear actuator 202 generally comprises a motor (not shown) that acts as a power source configured to dispose the linear actuator 202 in different positions. The motor may be responsive to signals from a processor (not shown) that control the degree of linear actuation. In embodiments where the linear actuator 202 is an electric linear actuator (e.g., a piezoelectric linear actuator) the motor may be a DC or stepper motor. In embodiments where the linear actuator 202 is a hydraulic linear actuator the motor may be a hydraulic pump. Alternatively, where the linear actuator 202 is a pneumatic linear actuator, the motor may be an air compressor. Generally, the motor is linked directly or indirectly to a lead or ball screw (not shown) that converts rotational motion generated by the motor into linear motion. The linear motion of the lead or ball screw will dispose the linear actuator in a variety of different positions along a linear axis.

The linear actuator 202 is coupled to a membrane support 208 defining a membrane aperture 210. The membrane aperture is generally disposed proximate a center of the membrane support 208 and defines a circular or substantially circular cross-section. The linear actuator 202 may comprise a pair of actuator arms 212 coupled to opposite ends of the membrane support 208. Generally, the pair of actuator arms 212 are linked directly or indirectly to the motor and lead or ball screw such that the pair of actuator arms 212 are displaced by the rotational motion of the motor and/or the linear motion of the lead or ball screw. In some embodiments, each actuator arm 212 will comprise its own motor such that the linear displacement of each actuator arm 212 is independent of the other. In alternative embodiments, both actuator arms comprise the same motor. Generally, the actuator arms 212 will have identical linear displacements from respective reference points such that the membrane support 208 is substantially perpendicular to the actuator arms 212. It will be appreciated that the membrane support 208 will be linearly displaced along with the actuator arms 212 to which it is coupled.

The adjustable port 104, 204 may be a deformable membrane 204. The deformable membrane 204 is coupled to the membrane support 208 such that the membrane aperture 210 and the variable area outlet aperture 206 are aligned. The deformable membrane 204 generally comprises a thin sheet of an elastomeric polymer (e.g., elastic silicone rubber). The deformable membrane 204 is cut from the thin sheet of the elastomeric polymer into a circular or substantially circular shape that is perforated with a small hole (i.e., the variable area outlet aperture 206) that is configured to act as an orifice through which printing feedstock is extruded. The membrane support 208 may be coupled to the membrane support 208 via a ring clamp (not shown) such that the membrane support 208 covers a portion of the membrane aperture 206. In some embodiments, substantially the entirety of the membrane aperture 206 is covered by the deformable membrane 204.

The additive manufacturing guide 200 may comprise a shaft 214. The shaft 214 defines a through space 216 and comprises a curved tip 218. The shaft 214 further defines a printing outlet 220 disposed proximate the variable area outlet aperture 206. Generally, the curved tip 218 of the shaft 214 contacts the deformable membrane 204. In some embodiments, the shaft 214 includes an optional mixer (not shown) configured for the static mixing of multi-part (e.g., two part) compositions.

Movement of the linear actuator 202 stretches or relaxes the deformable membrane 204 about the curved tip 218 of the shaft 214 to enlarge or shrink the variable area outlet aperture 206. Specifically, the curved tip 218 is pressed against the deformable membrane 204 such that internal stresses distributed evenly within the deformable membrane 204 cause the deformable membrane 204 to slide radially along a surface of the curved tip 218, which applies a radial shear at the variable area outlet aperture 206. This radial shear causes the deformable membrane 204 to dilate and expand the variable area outlet aperture 206 (e.g., up to 10× the original variable area outlet aperture 206 diameter). When fluid printing feedstock flows through the variable area outlet aperture 206, the extruded fluid printing feedstock conforms to the geometry of the dilated variable area outlet aperture 206, producing a print bead of the cross-section of the variable area outlet aperture 206 (e.g., a circular print bead) equal in diameter to the variable area outlet aperture 206. Pressure is relieved from the deformable membrane 204 when the shaft 214 is pulled away from the deformable membrane 204, causing the deformable membrane 204 to restore to an unstressed state, which constricts the variable area outlet aperture 206.

The linear actuator 202 controls the position of the membrane support 208, and therefore the deformable membrane 204, with respect to the curved tip 218 of the shaft 214. The linear actuators 202 mounted on either side of an additive manufacturing guide housing 222 pull the deformable membrane 204 against the curved tip 218 of the shaft 214 to dilate the variable area outlet aperture 204. Thus, smooth diametrical expansion and contraction of the variable outlet aperture 204 is controllable via linear motion.

The minimum print bead size is equal to the diameter of the variable area outlet aperture 206 in the minimum flow position of the additive manufacturing guide 200 when no stress is applied to the elastic aperture. The maximum print bead size is equal to the maximum dilation of the variable area outlet aperture 206 before the deformable membrane 204 is ruptured from internal stresses. Due to the elastic properties of the deformable membrane 204, any diameter between the minimum and maximum print bead size is theoretically achievable with the additive manufacturing guide 200, and is limited only by the resolution of the linear actuator 202. In this way, the additive manufacturing guide 200 is capable of smooth and continuous live-adjustment of the print bead throughout the manufacturing process. Furthermore, the deformable membrane 204 may comprise an isotropic material such that the deformable membrane 204 is symmetrically deformable and only the area of the variable area outlet aperture 206 is altered, while the shape of the variable outlet aperture 206 remains constant. The deformable membrane 204 may comprise an anisotropic material (e.g., a composite material) such that the deformable membrane 204 is unsymmetrically deformable and both the area and shape of the variable outlet aperture 206 is altered by deformation.

An additive manufacturing system (also referred to herein as the apparatus) comprising the additive manufacturing guide 100, 200 according to any of the embodiments described or envisioned herein is further provided. The apparatus is suitable for use in “additive manufacturing” (AM) or “3D printing” processes (i.e., is a “3D printer”). Accordingly, this disclosure generally incorporates by reference in its entirety ASTM Designation F2792-12a, “Standard Terminology for Additive Manufacturing Technologies.” Under this ASTM standard, “3D printer” is defined as “a machine used for 3D printing” and “3D printing” is defined as “the fabrication of objects through the deposition of a material using a print head, nozzle, or another printer technology”. Likewise, “additive manufacturing” is defined as “a process of joining materials to make objects from 3D model data, usually layer upon layer, as opposed to subtractive manufacturing methodologies. Synonyms associated with and encompassed by 3D printing include additive fabrication, additive processes, additive techniques, additive layer manufacturing, layer manufacturing, and freeform fabrication”. AM may also be referred to as rapid prototyping (RP). As used herein, “3D printing” is generally interchangeable with “additive manufacturing” and vice versa.

In general, 3D printing encompasses myriad types of specific AM processes, which are typically referred to or classified based on a particular class of 3D printer utilized in the 3D printing process. Examples of these specific types of 3D printing processes include direct extrusion additive manufacturing, liquid additive manufacturing, fused filament fabrication, fused deposition modeling, direct ink deposition, material jetting, polyjetting, syringe extrusion, laser sintering, laser melting, stereolithography, powder bedding (binder jetting), electron beam melting, laminated object manufacturing, laser powder forming, ink-jetting, and the like. Such processes may be used independently or in combination in the method of this disclosure. 3D printers include extrusion additive manufacturing printers, liquid additive manufacturing printers, fused filament fabrication printers, fused deposition modeling printers, direct ink deposition printers, selective laser sintering printers, selective laser melting printers, stereolithography printers, powder bed (binder jet) printers, material jet printers, direct metal laser sintering printers, electron beam melting printers, laminated object manufacturing deposition printers, directed energy deposition printers, laser powder forming printers, polyjet printers, ink-jetting printers, material jetting printers, and syringe extrusion printers.

In certain embodiments, the apparatus comprises a 3D printer selected from a fused filament fabrication printer, a fused deposition modeling printer, a direct ink deposition printer, a liquid additive manufacturing printer, a material jet printer, a polyjet printer, a material jetting printer, and a syringe extrusion printer.

Additionally, the 3D printer may be independently selected during each printing step associated with the disclosed method. Said differently, if desired, each printing step may utilize a different 3D printer or combinations of 3D printers. Different 3D printers may be utilized to impart different characteristics with respect to filaments and/or layers formed therewith, and different 3D printers may be particularly well suited for use with different types of compositions.

As the various types of 3D printing, and thus 3D printers, have substantial overlap with one another, e.g. based on a type of compositions and/or equipment utilized, 3D printers not specifically listed herein may also be utilized without departing from the scope of this disclosure. As such, the method of this disclosure can mimic (i.e., relate to) any one of the aforementioned 3D printing processes, or other 3D printing processes understood in the art. Specific examples of suitable 3D printing processes are also described in U.S. Pat. Nos. 5,204,055 and 5,387,380, the disclosures of which are incorporated herein by reference in their respective entireties.

As introduced above, regardless of its selection, the method utilizes the apparatus, e.g. the 3D printer, including the additive manufacturing guide 100, 200. However, other printing technology components, elements, or devices (e.g. physical and/or electronic) may be incorporated or used in conjunction with the apparatus and the additive manufacturing guide 100, 200. Examples of such components, elements, or devices include extruders, printing bases/platforms (e.g. stationary and/or motion controlled printing bases/platforms), various sensors/detectors (e.g. cameras, laser displacement sensors), computers and/or controllers, and the like, which may each be used independently or as part of a system (e.g. with the components in electronic communication with one another). Likewise, 3D printing is generally associated with a host of related technologies used to fabricate physical objects from computer generated data sources. Some of these specific processes are included above with reference to specific 3D printers. Further, some of these processes, and others, are described in greater detail below. Accordingly, many components and technologies may be utilized in connection with the method of this disclosure, as will be better understood in view of the general description of 3D printing process below.

The apparatus may further include a material feed system (not shown) which may include storage (e.g., a storage tank 224) and delivery mechanisms. The additive manufacturing system may comprise a motion system configured to direct or move the additive manufacturing guide 100, 200 and/or a printing surface (or printing substrate). The motion system may include mechanical components such as motors, belts, rails, or guide rods to control movements along one or more axis. In some embodiments, the additive manufacturing guide 100 is mounted to a mount 138 such that the mount 138 is fastened to the radial actuator seat 132 via a fastener disposed within the mount 138 and the mount fastening aperture 134 of the radial actuator seat 132.

A method of additive manufacturing with variable bead sizes using the additive manufacturing guide 100 is also provided. The method comprises the step of extruding a printing material out of the variable outlet aperture 106 defining a first area to form a first bead path having a first bead path width. The toric ballon 110 is inflated or deflated to compress or relax the network of metal rods 120 of the nozzle tip 104, therefore shrinking or enlarging the variable area outlet 106 to define a second area. The printing material is extruded out of the variable area outlet 106 defining the second area to form a second bead path having a second bead path width. The second area is smaller or larger than the first area, and the second bead path width is smaller or larger than the first bead path width. The method may be repeated multiple times to produce a layer comprising multiple bead widths. In some embodiments, the first or second area may be zero such that the layer defines one or more non-extrusion paths.

The method may further comprise the step of measuring the power required to maintain the variable area outlet aperture 106 at the first area or the second area against a force of the printing material acting on the nozzle tip 104. The force of the printing material acting on the nozzle tip 104 is calculated from the power required to maintain the variable area outlet aperture at the first area or the second area. A fluid flow rate of the printing material is calculated from the force of the printing material acting on the nozzle tip 104. The toric ballon 110 is inflated or deflated to compress or relax the network of metal rods 120 of the nozzle tip 104 and shrink or enlarge the variable area outlet aperture 106 to adjust the fluid flow rate to a target fluid flow rate.

A method of additive manufacturing with variable bead sizes using the additive manufacturing guide 100, 200 is further provided. In general, 3D printing processes have a common starting point, which is a computer generated data source or program which may describe an object. The computer generated data source or program can be based on an actual or virtual object. For example, an actual object can be scanned using a 3D scanner to give scan data, and the scan data can be used to make the computer generated data source or program. Alternatively, the computer generated data source or program may be designed from scratch, e.g. wholly or in combination with scan data.

Generally, an additive manufacturing process begins when a computer generated data source or program is converted into a standard tessellation language (STL) file format; however, other file formats can also or additionally be used. The file is generally read into 3D printing software, which takes the file and optionally user input to separate it into hundreds, thousands or even millions of “slices”. The 3D printing software typically outputs machine instructions, which may be in the form of G-code, which is read by the 3D printer to build each slice. The machine instructions are transferred to the 3D printer, which then builds the object layer-by-layer based on this slice information in the form of the machine instructions. Thicknesses of these slices may vary.

To affect the layer-by-layer printing, the nozzle and/or the build platform of the 3D printer generally moves in the X-Y (horizontal) plane before moving in the Z-axis (vertical) plane once each layer is complete. In this way, the object which becomes the 3D article is built one layer at a time from the bottom upwards. This process can use material for two different purposes, building the object and supporting overhangs in order to avoid extruding material into thin air. Alternatively, the nozzle moves in the vertical and horizontal planes simultaneously such that the layers are integrated and at least partially overlap in the Z-axis.

Optionally, the resulting objects may be subjected to different post-processing regimes, such as further heating, solidification, infiltration, bakeout, and/or firing. This may be done, for example, to expedite cure of any binder, to reinforce or form the 3D article from the object, to eliminate any curing/cured binder (e.g., by decomposition), to consolidate the core material (e.g., by sintering/melting), and/or to form a composite material blending the properties of powder and binder.

In various embodiments, the method of this disclosure mimics a conventional material extrusion process. Material extrusion generally works by extruding material (in this case, the printing material) through a nozzle to print one cross-section of an object, which may be repeated for each subsequent layer. The nozzle may be heated, cooled or otherwise manipulated during printing, which may aid in dispensing the particular composition.

The method comprises extruding a printing material out of the variable area outlet aperture 206 defining a first area to form a first bead path having a first bead path width. The linear actuator 202 is linearly displaced from a first position to a second position to stretch or relax the deformable membrane 204 about the curved tip 218 of the shaft 214 to enlarge or shrink the variable area outlet aperture 206 to define a second area. The printing material is extruded out of the variable area outlet aperture 206 to form a second bead path having a second bead path width. The second area is smaller or larger than the first area, and the second bead path width is smaller or larger than the first bead path width. The method may be repeated multiple times to produce a layer comprising multiple bead widths. In some embodiments, the first or second area may be zero such that the layer defines one or more non-extrusion paths.

The method may further comprise the step of measuring the power required to maintain the variable area outlet aperture 206 at the first area or the second area against a force of the printing material acting on the deformable membrane 204. The force of the printing material acting on the deformable membrane 204 is calculated from the power required to maintain the variable area outlet aperture 206. The fluid flow rate of the printing material is calculated from the force of the printing material acting on the deformable membrane 204. The linear actuator 202 is linearly displaced from a first position to a second position to stretch or relax the deformable membrane 204 about the curved tip 218 of the shaft 214 to enlarge or shrink the variable area outlet aperture 206 to adjust the fluid flow rate to a target fluid flow rate.

The printing material is described in further detail herein, and is to be understood in view of the description and examples below relating to first composition itself as well as “the compositions” described further below. Generally, the printing material may be any composition suitable for use in forming a 3D article via printing.

The properties of the printing material may vary, and are typically dependent on the particular composition(s) utilized in the printing material. For example, the viscosity of the printing material may be any viscosity suitable for printing. Generally, the viscosity of the printing material is selected to provide a flowable printing liquid. Alternatively, the viscosity of the printing material may be selected to provide a deformable first filament, as described below, a degree of self-support when formed on the substrate. As such, the viscosity of the printing material may be defined as a dynamic viscosity, which may be in the range of from 1000 to 100,000,000 centipoise (cP), such as from 30,000 to 5,000,000 cP, where 1 cP is equal to 1 mPa·s. For greater printing speed and interlayer adhesion, the printing material may be “thixotropic”. Viscosity values herein are at 25° C. unless otherwise expressly indicated. The viscosity of the printing material may be altered (i.e. increased or decreased) by heating or cooling the printing material, e.g. via heat transfer to or from the additive manufacturing guide 100, 200 or a printing substrate (not shown), altering the ambient conditions, etc., as described below. Likewise, the elastic modulus of the printing material may vary, e.g. based on the particular printing parameters selected, the compositions employed, the 3D article to be formed, etc. Additionally, the elastic modulus of the first composition may change over time, e.g. due to curing, crosslinking, and/or hardening of the printing material, including during the method. Typically, the elastic modulus of the printing material is in the range of from 0.01 to 5000 MPa, such as from 0.1 to 1500, from 0.1 to 500, from 0.1 to 125, from 0.2 to 100, from 0.2 to 90, from 0.2 to 80, from 0.3 to 80, from 0.3 to 70, from 0.3 to 60, from 0.3 to 50, from 0.3 to 45, from 0.4 to 40, or from 0.5 to 10 MPa. These ranges may apply to the elastic modulus of the printing material at any time, such as before printing, during printing, and/or after printing. Moreover, more than one of such ranges may apply to the printing material, e.g. when the elastic modulus of the printing material may changes over time (e.g. during and/or after printing). In certain embodiments, the printing material has an elastic modulus of less than 120, alternatively less than 110, alternatively less than 100, alternatively less than 90, alternatively less than 80, alternatively less than 70, alternatively less than 60, alternatively less than 50, alternatively less than 40, alternatively less than 30 MPa during printing.

The properties of the printing material may be selected such that the printing material comprises an ability to be deformed in response to an applied force (i.e., deformability) and an ability to undergo liquid and/or plastic flow (i.e., flowability) during printing. As described further below, such deformability and/or flowability characteristics may be selected (i.e., tuned), e.g. based on the particular components selected for use in or as the printing material. Additionally, the deformability and flowability of the printing material may change over time, e.g. due to curing, crosslinking, and/or hardening.

The printing material is passed through the additive manufacturing guide 100, 200 and expelled (e.g. extruded or dispensed) from the adjustable port 104, 204. Accordingly, the dimensions (i.e., cross sectional shape, height, width, diameter, etc.) of the printing material as printed are typically influenced and/or dictated by the perimeter shape and/or dimensions of the cavity. Likewise, the form of the printing material during printing may also be selected and influenced and/or dictated by the nozzle, as described in further detail below.

The printing material may be printed in any form. In some embodiments, the printing material is printed on the deformable substrate as a deformable first filament, such that the first layer formed therefrom comprises the deformable first filament. The term “filament” is used herein to describe a thread-like form, e.g. comprising one or more strands and/or fibers. However, as described below, each of such filaments, or combination of such filaments, may be formed, oriented, arranged, or otherwise disposed in various secondary and/or tertiary forms, as described below. Likewise, each filament may be continuous or discontinuous with respect to length, i.e., may be a single unbroken filament, or may comprise a plurality of separate filaments. For example, in certain embodiments, the deformable first filament may be continuous or discontinuous with respect to length. In other words, the deformable first filament may be a single unbroken filament, or may comprise a plurality of separate filaments. For purposes of clarity, the term “deformable first filament” is used herein to refer to the deformable first filament in its entirety, and extends to and encompasses both a single filament or a plurality of filaments comprising the printing material, which each may be independently selected and formed in the first layer, and are each typically deformable. Likewise, with respect to any other filaments described herein, the term “filament” itself may refer to, and thus encompasses, both a single filament or a plurality of filament comprising a composition (e.g. the printing material, or any other composition described herein).

As introduced above, the deformable first filament itself may comprise any form. For example, the deformable first filament may be randomized, patterned, linear, non-linear, woven, non-woven, continuous, discontinuous, or may have any other form or combinations of forms. For example, the deformable first filament may be a mat, a web, or have other orientations. The deformable first filament may be patterned such that the first layer comprises the deformable first filament in a nonintersecting manner. For example, the deformable first filament may comprise a plurality of linear and parallel filaments or strands. Alternatively, the deformable first filament may intersect itself such that the first layer itself comprises a patterned or cross-hatched filament. The pattern or cross-hatching of the deformable first filament may present perpendicular angles, or acute/obtuse angles, or combinations thereof, at each intersecting point of the deformable first filament, which orientation may be independently selected at each intersecting point. Further still, the deformable first filament may contact and fuse or blend with itself such that portions of, alternatively the entirety of, the first layer is in the form of a film.

In certain embodiments, the deformable first filament may fuse with itself to define a void, alternatively a plurality of voids, in the first layer. Typically, however, the deformable first filament is formed on the deformable substrate such that voids between fusions are minimized or eliminated, and the first layer is free from, alternatively is substantially free from, voids. The void-filling ability of the deformable first filament may be influenced (i.e., selectively increased or decreased) by the particular components selected for use in the printing material (e.g. to influence the viscosity, flowability, etc. thereof), as described further below.

As introduced above, the printing material is passed through the additive manufacturing guide 100, 200 and expelled (e.g. extruded) through the adjustable port 104, 204. Accordingly, the overall shape of the adjustable port 104, 204, in conjunction with the elastic modulus of the printing material, influence and/or dictate dimensions of the deformable first filament formed from the printing material affects the geometry of the extruded printing material. For example, the additive manufacturing guide 100, 200 may include a reducing tip (i.e., having a tip ID (di) less than a base ID), such that the printing material is radially compressed while passed through the adjustable port 104, 204. In such instances, the viscoelastic properties of the printing material and the extrusion speed will dictate the degree to which the deformable first filament will decompress to an outer diameter greater than the tip ID (di) of the additive manufacturing guide 104, 204. Additionally, as described in further detail below, a shape of an outer portion of the additive manufacturing guide 100, 200 (e.g. proximate the adjustable port 104, 204) may influence a dimension and/or shape of the deformable first filament, such as when the adjustable port 104, 204 height is less than a height of the deformable first filament and the outer portion of the nozzle contacts a surface of the filament. In these instances, the adjustable port 104, 204 may be used to deform (e.g. “smooth”) an otherwise cylindrically-shaped first filament, e.g. to flatten the top thereof, to outwardly spread the deformable first filament (e.g. to fill voids adjacent thereto), etc.

The printing material may comprise one or more compositions (e.g., a printing material and a second composition). In certain embodiments, at least one of the compositions, e.g. the first composition, the second composition, and/or any subsequent or additional compositions, comprises: (a) a resin; (b) a silicone composition; (c) a metal; (d) a slurry; or (e) a combination of (a) to (d). In specific embodiments, the additive manufacturing guide 100, 200 is used in the printing of silicone compositions.

In certain embodiments, at least one of the compositions, e.g. the first composition, the second composition, and/or any subsequent or additional compositions, comprises the resin. As will be understood in view of the description herein, the resin may comprise, alternatively may be, an organic resin, a silicone resin, or combinations thereof. Specific examples of suitable organic resins are described below with general respect to the resin, and specific examples of suitable silicone resins are described further below with respect to various components of the silicone composition. In this sense, the silicone resins exemplified for use in the silicone composition may additionally or alternatively used in or as the resin in any of the compositions described herein.

The term “resin” is conventionally used to describe a composition that comprises a polymer (e.g. natural or synthetic) and is capable of being cured and/or hardened (i.e., the resin comprises the composition in an uncured and/or unhardened state). However, the term “resin” is also conventionally used to denote a composition comprising a natural or synthetic polymer in a cured and/or hardened state. As such, the term “resin” may be used in either conventional sense to refer to a cured and/or hardened resin, or to an uncured and/or unhardened resin. Accordingly, as used herein, the general term “resin” may refer to a cured or an uncured resin, and the more specific terms “cured resin” and “uncured resin” are used to differentiate between a particular resin in a cured or uncured state. It is also to be understood that the term “uncured” refers to a composition or component that is not fully cross-linked and/or polymerized, as described below. For example, and “uncured” resin may have undergone little to no crosslinking, or may be cross-linked at an amount of less than 100% of available cure sites, e.g. at an amount of from about 10 to about 98, about 15 to about 95, about 20 to about 90, about 20 to about 85, or about 20 to about 80% of available cure sites. Conversely, the term “cured” may refer to the composition when it us completely cross-linking, or has undergone enough crosslinking to achieve a property or characteristic typically ascribed to a cured composition. However, some of the available cure sites in a cured composition may remain uncross-linked. Likewise, it is to be understood that some of the available cure sites in an uncured composition may be cross-linked. Thus, the terms “cured” and “uncured” may be understood to be functional and/or descriptive terms. For example, a cured resin is typically characterized by an insolubility in organic solvents, an absence of liquid and/or plastic flow under ambient conditions, and/or a resistance to deformation in response to an applied force. In contrast, an uncured resin is typically characterized by a solubility in organic solvents, an ability to undergo liquid and/or plastic flow, and/or an ability to be deformed in response to an applied force (e.g. effected by the printing process). In some embodiments, the composition comprises an uncured resin. In such embodiments, the uncured resin may be present in the composition in an uncured state, but may be capable of being cured (e.g. via reaction of the uncured resin with another component of the composition, via exposure to a curing condition, etc.). The uncured resin, once cured, may no longer be deformable.

Generally, examples of suitable resins comprise reaction products of monomeric units (e.g. monomers, oligomers, polymers, etc.) and curing agents. Curing agents suitable for use in forming such resins typically include at least difunctional molecules that are reactive with functional groups present in the resin-forming monomeric unit. For example, curing agents suitable for use in forming epoxy resins are typically at least difunctional molecules that are reactive with epoxide groups (i.e., comprise two or more epoxide-reactive functional groups). As understood in the art, the terms “curing agent” and “cross-linking agent” can be used interchangeably. Additionally, the curing agent may itself be a monomeric unit, such that resin comprises a reaction product of at least two monomeric unites, which may be the same as or different from one another.

Suitable resins are conventionally named/identified according to a particular functional group present in the reaction product. For example, the term “polyurethane resin” represents a polymeric compound comprising a reaction product of an isocyanate (i.e., a monomeric unit comprising isocyanate functionality) and a polyol (i.e., a chain extender/curing agent comprising alcohol functionalities). The reaction of the isocyanate and the polyol create urethane functional groups, which were not present in either of the unreacted monomer or curing agent. In certain instances, however, resins are named according to a particular functional group present in the monomeric unit (i.e., the functionality at a cure site). For example, the term “epoxy resin” represents a polymeric compound comprising a cross-linked reaction product of a monomeric unit having one or more epoxide groups (i.e., epoxide functionalities) and a curing agent. However, once cured, the epoxy resin is no longer an epoxy, or no longer includes epoxide groups, but for any unreacted or residual epoxide groups (i.e., cure sites), which may remain after curing, as understood in the art. In other instances, however, suitable resins may comprise the reaction product of one or more monomeric units (i.e., where the curing agent itself is also a monomeric unit), each having the same functionality both prior to and after the reaction. In such instances, the resins may be named according to a functional group present in both the monomeric unit and the reaction product (e.g. an unreacted functional group, or a functional group that is modified during reaction but does not change in kind/name). For example, the term “silicone resin” represents a siloxane-functional polymeric compound comprising a reaction product of a monomeric unit comprising a siloxane functional group. Certain examples of suitable resins comprise long chain thermoplastics such as thermoplastic elastomers (TPE), and reaction products of monomeric units (e.g. monomers, oligomers, polymers, etc.) and curing agents.

In some embodiments, the resin comprises a thermosetting and/or thermoplastic resin. The terms “thermosetting” and “thermoplastic” are used herein the conventional sense, any may thus be understood as descriptive and/or functional characterizations of particular resins. By way of example, the term “thermoplastic” typically describes a resin (e.g. a plastic) that becomes pliable and/or moldable above a specific temperature (e.g. transition temperature, such as a Tg), and also solidifies upon cooling below a specific temperature. Moreover, a “thermoplastic” can typically be remolded into a new shape, e.g. after heating a molded thermoplastic article above the specific temperature to regain pliability prior to and/or during remolding. In contrast, the term “thermoset” typically describes a resin (e.g. a plastic) that is irreversibly cured from a soft solid or viscous liquid (e.g. an uncured resin). As such, once cured/hardened, a “thermoset” typically cannot be remolded into a new shape via reheating (e.g. to do comprising a Tg greater than a temperature at which the thermoset loses one or more material properties and/or decomposes).

Specific examples of suitable resins typically include polyamides (PA), such as Nylons; polyesters such as polyethylene terephthalates (PET), polybutylene terephthalates (PET), polytrimethylene terephthalates (PTT), polyethylene naphthalates (PEN), liquid crystalline polyesters, and the like; polyolefins such as polyethylenes (PE), polypropylenes (PP), polybutylenes, and the like; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones (PEK); polyetheretherketones (PEEK); polyetherketoneketones (PEKK); polyarylates (PAR); polyethernitriles (PEN); resol-type; urea (e.g. melamine-type); phenoxy resins; fluorinated resins, such as polytetrafluoroethylenes; thermoplastic elastomers, such as polystyrene types, polyolefin types, polyurethane types, polyester types, polyamide types, polybutadiene types, polyisoprene types, fluoro types, and the like; and copolymers, modifications, and combinations thereof. Additionally, elastomers and/or rubbers can be added to or compounded with the resin, e.g. to improve certain properties in the uncured resin, such as deformability, cure time, etc., and/or in the cured resin (and thus the 3D article), such as flexibility, impact strength, etc. In some embodiments, the resin may be disposed in a vehicle or solvent.

In certain embodiments, at least one of the compositions, e.g. the first composition, the second composition, and/or any subsequent or additional compositions, comprises the silicone composition, which may be a rubber or elastomer silicone composition. In such embodiments, the 3D article may be utilized in biological and/or health care applications in view of the excellent compatibility between silicones and biological systems. Suitable silicone compositions may be independently selected from (a) hydrosilylation-curable silicone compositions; (b) condensation-curable silicone compositions; (c) thiol-ene reaction-curable silicone compositions; (d) free-radical-curable silicone compositions; and (e) ring-opening reaction curable silicone compositions. In these embodiments, the silicone compositions are generally curable such that exposure to the solidification condition may be referred to as exposure to a curing condition. As understood in the art, these silicone compositions may be cured via different curing conditions, such as exposure to moisture, exposure to heat, exposure to irradiation, etc. Moreover, these silicone compositions may be curable upon exposure to different types of curing conditions, e.g. both heat and irradiation, which may be utilized together or as only one. In addition, exposure to a curing condition may cure or initiate cure of different types of silicone compositions. For example, heat may be utilized to cure or initiate cure of condensation-curable silicone compositions, hydrosilylation-curable silicone compositions, and free radical-curable silicone compositions.

The silicone compositions may have the same cure mechanism upon application of the curing condition, but may still be independently selected from one another. For example, the first composition may comprise a condensation-curable silicone composition, and the second composition may also comprise a condensation-curable silicone composition, wherein the condensation-curable silicone compositions differ from one another, e.g. by components, relative amounts thereof, etc.

In certain embodiments, each of the silicone compositions utilized in the method cures via the same cure mechanism upon application of the curing condition. These embodiments easily allow for cure across the print line, if desired, as the components of in each of the silicone compositions may readily react with one another in view of having the same cure mechanism upon application of the curing condition. In these embodiments, each of the silicone compositions may still differ from one another in terms of the actual components utilized and relative amounts thereof, even though the cure mechanism is the same in each of the silicone compositions. In contrast, although there may be some cure across the print line when each of the layers cures via a different mechanism (e.g. hydrosilylation versus condensation), components in these layers may not be able to react with one another upon application of the curing condition, which may be desirable in other applications.

In certain embodiments, at least one of the silicone compositions comprises a hydrosilylation-curable silicone composition. In these embodiments, the hydrosilylation-curable silicone composition typically comprises: (A) an organopolysiloxane having an average of at least two silicon-bonded alkenyl groups or silicon-bonded hydrogen atoms per molecule; (B) an organosilicon compound having an average of at least two silicon-bonded hydrogen atoms or silicon-bonded alkenyl groups per molecule capable of reacting with the silicon-bonded alkenyl groups or silicon-bonded hydrogen atoms in the organopolysiloxane (A); and (C) a hydrosilylation catalyst. When the organopolysiloxane (A) includes silicon-bonded alkenyl groups, the organosilicon compound (B) includes at least two silicon-bonded hydrogen atoms per molecule, and when the organopolysiloxane (A) includes silicon-bonded hydrogen atoms, the organosilicon compound (B) includes at least two silicon-bonded alkenyl groups per molecule. The organosilicon compound (B) may be referred to as a cross-linker or cross-linking agent. In certain embodiments, the organopolysiloxane (A) and/or the organosilicon compound (B) may independently include more than two hydrosilylation-reactive functional groups (e.g. silicon-bonded alkenyl groups and/or silicon-bonded hydrogen atoms per molecule, such as an average of 3, 4, 5, 6, or more hydrosilylation-reactive functional groups per molecule. In such embodiments, the hydrosilylation-curable silicone composition may be formulated to be chain-extendable and cross-linkable via hydrosilylation, such as by differing the number and/or type of hydrosilylation-reactive functional groups per molecule of the organopolysiloxane (A) from the number and/or type of hydrosilylation-reactive functional groups per molecule of the organosilicon compound (B). For example, in these embodiments, when the organopolysiloxane (A) includes at least two silicon-bonded alkenyl groups per molecule, the organosilicon compound (B) may include at least three silicon-bonded hydrogen atoms per molecule, and when the organopolysiloxane (A) includes at least two silicon-bonded hydrogen atoms, the organosilicon compound (B) may include at least three silicon-bonded alkenyl groups per molecule. Accordingly, the ratio of hydrosilylation-reactive functional groups per molecule of the organopolysiloxane (A) to hydrosilylation-reactive functional groups per molecule of the organosilicon compound (B) may be equal to, less than, or greater than 1:1, such as from 1:5 to 5:1, alternatively from 1:4 to 4:1, alternatively from 1:3 to 3:1, alternatively from 1:2 to 2:1, alternatively from 2:3 to 3:2, alternatively from 3:4 to 4:3.

The organopolysiloxane (A) and the organosilicon compound (B) may independently be linear, branched, cyclic, or resinous. In particular, the organopolysiloxane (A) and the organosilicon compound (B) may comprise any combination of M, D, T, and Q units. The symbols M, D, T, and Q represent the functionality of structural units of organopolysiloxanes. M represents the monofunctional unit R⁰₃SiO_{1/2}. D represents the difunctional unit R⁰₂SiO_{2/2}. T represents the trifunctional unit R⁰SiO_{3/2}. Q represents the tetrafunctional unit SiO_{4/2}. Generic structural formulas of these units are shown below:

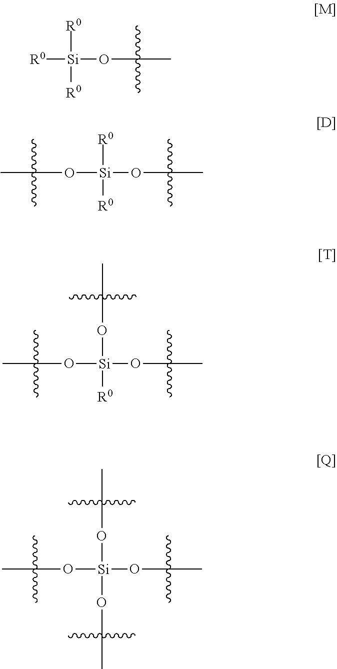

In these structures/formulae, each R⁰ may be any hydrocarbon, aromatic, aliphatic, alkyl, alkenyl, or alkynyl group.

The particular organopolysiloxane (A) and organosilicon compound (B) may be selected based on desired properties of the 3D article and layers during the method. For example, it may be desirable for the layers to be in the form of an elastomer, a gel, a resin, etc., and selecting the components of the silicone composition allows one of skill in the art to achieve a range of desirable properties.

For example, in certain embodiments, one of the organopolysiloxane (A) and the organosilicon compound (B) comprises a silicone resin, which typically comprises T and/or Q units in combination with M and/or D units. When the organopolysiloxane (A) and/or organosilicon compound (B) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the hydrosilylation-curable silicone composition comprises a resin, the layer(s) and resulting 3D article have increased rigidity.

Alternatively, in other embodiments, the organopolysiloxane (A) and/or the organosilicon compound (B) is an organopolysiloxane comprising repeating D units. Such organopolysiloxanes are substantially linear but may include some branching attributable to T and/or Q units. Alternatively, such organopolysiloxanes are linear. In these embodiments, the layer(s) and resulting 3D article are elastomeric.

The silicon-bonded alkenyl groups and silicon-bonded hydrogen atoms of the organopolysiloxane (A) and the organosilicon compound (B), respectively, may independently be pendent, terminal, or in both positions.

In a specific embodiment, the organopolysiloxane (A) has the general formula:

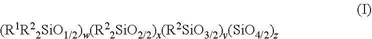

wherein each R¹ is an independently selected hydrocarbyl group, which may be substituted or unsubstituted, and each R² is independently selected from R¹ and an alkenyl group, with the proviso that at least two of R² are alkenyl groups, and w, x, y, and z are mole fractions such that w+x+y+z=1. As understood in the art, for linear organopolysiloxanes, subscripts y and z are generally 0, whereas for resins, subscripts y and/or z>0. Various alternative embodiments are described below with reference to w, x, y and z. In these embodiments, the subscript w may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x typically has a value of from 0 to 0.999, alternatively from 0 to 0.45, alternatively from 0 to 0.25. The subscript y typically has a value of from 0 to 0.99, alternatively from 0.25 to 0.8, alternatively from 0.5 to 0.8. The subscript z typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

In certain embodiments, each R¹ is a C₁ to C₁₀ hydrocarbyl group, which may be substituted or unsubstituted, and which may include heteroatoms within the hydrocarbyl group, such as oxygen, nitrogen, sulfur, etc. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl groups, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl groups, such as cyclopentyl, cyclohexyl, and methylcyclohexyl; aryl groups, such as phenyl and naphthyl; alkaryl groups, such as tolyl and xylyl; and aralkyl groups, such as benzyl and phenethyl. Examples of halogen-substituted hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

The alkenyl groups represented by R², which may be the same or different within the organopolysiloxane (A), typically have from 2 to 10 carbon atoms, alternatively from 2 to 6 carbon atoms, and are exemplified by, for example, vinyl, allyl, butenyl, hexenyl, and octenyl.

In these embodiments, the organosilicon compound (B) may be further defined as an organohydrogensilane, an organopolysiloxane an organohydrogensiloxane, or a combination thereof. The structure of the organosilicon compound (B) can be linear, branched, cyclic, or resinous. In acyclic polysilanes and polysiloxanes, the silicon-bonded hydrogen atoms can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms. The organohydrogensilane can be a monosilane, disilane, trisilane, or polysilane.

Hydrosilylation catalyst (C) includes at least one hydrosilylation catalyst that promotes the reaction between the organopolysiloxane (A) and the organosilicon compound (B). The hydrosilylation catalyst (C) can be any of the well-known hydrosilylation catalysts comprising a platinum group metal (i.e., platinum, rhodium, ruthenium, palladium, osmium and iridium) or a compound containing a platinum group metal. Typically, the platinum group metal is platinum, based on its high activity in hydrosilylation reactions.

Specific hydrosilylation catalysts suitable for (C) include the complexes of chloroplatinic acid and certain vinyl-containing organosiloxanes disclosed by Willing in U.S. Pat. No. 3,419,593, the portions of which address hydrosilylation catalysts are hereby incorporated by reference. A catalyst of this type is the reaction product of chloroplatinic acid and 1,3-diethenyl-1,1,3,3-tetramethyldisiloxane.

The hydrosilylation catalyst (C) can also be a supported hydrosilylation catalyst comprising a solid support having a platinum group metal on the surface thereof. A supported catalyst can be conveniently separated from organopolysiloxanes, for example, by filtering the reaction mixture. Examples of supported catalysts include, but are not limited to, platinum on carbon, palladium on carbon, ruthenium on carbon, rhodium on carbon, platinum on silica, palladium on silica, platinum on alumina, palladium on alumina, and ruthenium on alumina.

In addition or alternatively, the hydrosilylation catalyst (C) can also be a microencapsulated platinum group metal-containing catalyst comprising a platinum group metal encapsulated in a thermoplastic resin. Hydrosilylation-curable silicone compositions including microencapsulated hydrosilylation catalysts are stable for extended periods of time, typically several months or longer, under ambient conditions, yet cure relatively rapidly at temperatures above the melting or softening point of the thermoplastic resin(s). Microencapsulated hydrosilylation catalysts and methods of preparing them are well known in the art, as exemplified in U.S. Pat. No. 4,766,176 and the references cited therein, and U.S. Pat. No. 5,017,654. The hydrosilylation catalyst (C) can be a single catalyst or a mixture comprising two or more different catalysts that differ in at least one property, such as structure, form, platinum group metal, complexing ligand, and thermoplastic resin.

The hydrosilylation catalyst (C) may also, or alternatively, be a photoactivatable hydrosilylation catalyst, which may initiate curing via irradiation and/or heat. The photoactivatable hydrosilylation catalyst can be any hydrosilylation catalyst capable of catalyzing the hydrosilylation reaction, particularly upon exposure to radiation having a wavelength of from 150 to 800 nanometers (nm).

Specific examples of photoactivatable hydrosilylation catalysts include, but are not limited to, platinum(II) β-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene.Pt[p-CN—C₆H₄NNNOC₆H₁₁]₂, 1,5-cyclooctadiene.Pt[p-CH₃O—C₆H₄NNNOCH₃]₂, [(C₆H₅)₃P]₃Rh[p-CN—C₆H₄NNNOC₆H₁₁], and Pd[p-CH₃(CH₂)ₓ—C₆H₄NNNOCH₃]₂, where x is 1, 3, 5, 11, or 17; (η-diolefin) (o-aryl)platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl)platinum, (η⁴-1,5-cyclooctadienyl)bis-(4-acetylphenyl)platinum, and (η⁴-1,5-cyclooctadienyl)bis-(4-trifluormethylphenyl)platinum. Typically, the photoactivatable hydrosilylation catalyst is a Pt(II) β-diketonate complex and more typically the catalyst is platinum(II) bis(2,4-pentanedioate). The hydrosilylation catalyst (C) can be a single photoactivatable hydrosilylation catalyst or a mixture comprising two or more different photoactivatable hydrosilylation catalysts.

The concentration of the hydrosilylation catalyst (C) is sufficient to catalyze the addition reaction between the organopolysiloxane (A) and the organosilicon compound (B). In certain embodiments, the concentration of the hydrosilylation catalyst (C) is sufficient to provide typically from 0.1 to 1000 ppm of platinum group metal, alternatively from 0.5 to 100 ppm of platinum group metal, alternatively from 1 to 25 ppm of platinum group metal, based on the combined weight of the organopolysiloxane (A) and the organosilicon compound (B).

The hydrosilylation-curable silicone composition may be a two-part composition where the organopolysiloxane (A) and organosilicon compound (B) are in separate parts. In these embodiments, the hydrosilylation catalyst (C) may be present along with either or both of the organopolysiloxane (A) and organosilicon compound (B). Alternatively still, the hydrosilylation catalyst (C) may be separate from the organopolysiloxane (A) and organosilicon compound (B) in a third part such that the hydrosilylation reaction-curable silicone composition is a three-part composition.

In one specific embodiment the hydrosilylation-curable silicone composition comprises ViMe₂(Me₂SiO)₁₂₈SiMe₂Vi as the organopolysiloxane (A), MegSiO(Me₂SiO)₁₄(MeHSiO)₁₆SiMe₃ as the organosilicon compound (B) and a complex of platinum with divinyltetramethyldisiloxane as (C) such that platinum is present in a concentration of 5 ppm based on (A), (B) and (C).

Solidification conditions for such hydrosilylation-curable silicone compositions may vary. For example, hydrosilylation-curable silicone composition may be solidified or cured upon exposure to irradiation and/or heat. One of skill in the art understands how selection of the hydrosilylation catalyst (C) impacts techniques for solidification and curing. In particular, photoactivatable hydrosilylation catalysts are typically utilized when curing via irradiation is desired.

In these or other embodiments, at least one of the silicone compositions comprises a condensation-curable silicone composition. In these embodiments, the condensation-curable silicone composition typically comprises (A′) an organopolysiloxane having an average of at least two silicon-bonded hydroxyl or hydrolysable groups per molecule; optionally (B′) an organosilicon compound having an average of at least two silicon-bonded hydrogen atoms, hydroxyl groups, or hydrolysable groups per molecule; and (C′) a condensation catalyst. Although any parameter or condition may be selectively controlled during the method or any individual step thereof, relative humidity and/or moisture content of ambient conditions may be selectively controlled to further impact a cure rate of condensation-curable silicone compositions.

The organopolysiloxane (A′) and the organosilicon compound (B′) may independently be linear, branched, cyclic, or resinous. In particular, the organopolysiloxane (A′) and the organosilicon compound (B′) may comprise any combination of M, D, T, and Q units, as with the organopolysiloxane (A′) and the organosilicon compound (B′) disclosed above.

The particular organopolysiloxane (A′) and organosilicon compound (B′) may be selected based on desired properties of the 3D article and layers during the method. For example, it may be desirable for the layers to be in the form of an elastomer, a gel, a resin, etc., and selecting the components of the silicone composition allows one of skill in the art to achieve a range of desirable properties.

For example, in certain embodiments, one of the organopolysiloxane (A′) and the organosilicon compound (B′) comprises a silicone resin, which typically comprises T and/or Q units in combination with M and/or D units. When the organopolysiloxane (A′) and/or organosilicon compound (B′) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the condensation-curable silicone composition comprises a resin, the layer(s) and resulting 3D article have increased rigidity.

Alternatively, in other embodiments, the organopolysiloxane (A′) and/or the organosilicon compound (B′) is an organopolysiloxane comprising repeating D units. Such organopolysiloxanes are substantially linear but may include some branching attributable to T and/or Q units. Alternatively, such organopolysiloxanes are linear. In these embodiments, the layer(s) and resulting 3D article are elastomeric.

The silicon-bonded hydroxyl groups and silicon-bonded hydrogen atoms, hydroxyl groups, or hydrolysable groups of the organopolysiloxane (A′) and the organosilicon compound (B′), respectively, may independently be pendent, terminal, or in both positions.

As known in the art, silicon-bonded hydroxyl groups result from hydrolyzing silicon-bonded hydrolysable groups. These silicon-bonded hydroxyl groups may condense to form siloxane bonds with water as a byproduct.

Examples of hydrolysable groups include the following silicon-bonded groups: H, a halide group, an alkoxy group, an alkylamino group, a carboxy group, an alkyliminoxy group, an alkenyloxy group, or an N-alkylamido group. Alkylamino groups may be cyclic amino groups.

In a specific embodiment, the organopolysiloxane (A′) has the general formula:

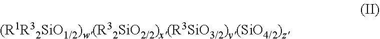

wherein each R¹ is defined above and each R³ is independently selected from R¹ and a hydroxyl group, a hydrolysable group, or combinations thereof with the proviso that at least two of R³ are hydroxyl groups, hydrolysable groups, or combinations thereof, and w′, x′, y′, and z′ are mole fractions such that w′+x′+y′+z′=1. As understood in the art, for linear organopolysiloxanes, subscripts y′ and z′ are generally 0, whereas for resins, subscripts y′ and/or z′>0. Various alternative embodiments are described below with reference to w′, x′, y′ and z′. In these embodiments, the subscript w′ may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x′ typically has a value of from 0 to 0.999, alternatively from 0 to 0.45, alternatively from 0 to 0.25. The subscript y′ typically has a value of from 0 to 0.99, alternatively from 0.25 to 0.8, alternatively from 0.5 to 0.8. The subscript z′ typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

As set forth above, the condensation-curable silicone composition further comprises the organosilicon compound (B′). The organosilicon compound (B′) may be linear, branched, cyclic, or resinous. In one embodiment, the organosilicon compound (B′) has the formula R¹_{q}SiX_{4-q}, wherein R¹ is defined above, X is a hydrolysable group, and q is 0 or 1.

Specific examples of organosilicon compounds (B′) include alkoxy silanes such as MeSi(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂=CHSi(OCOCH₃)₃; organoiminooxysilanes such as CH₃Si[O—N═C(CH₃)CH₂CH₃]₃, Si[O—N═C(CH₃)CH₂CH₃]₄, and CH₂=CHSi[O—N═C(CH₃)CH₂CH₃]₃; organoacetamidosilanes such as CH₃Si[NHC(═O)CH₃]₃ and C₆H₅Si[NHC(═O)CH₃]₃; amino silanes such as CH₃Si[NH(C₄H₉)]₃ and CH₃Si(NHC₆H₁₁)₃; and organoaminooxysilanes.

The organosilicon compound (B′) can be a single silane or a mixture of two or more different silanes, each as described above. Also, methods of preparing tri- and tetra-functional silanes are well known in the art; many of these silanes are commercially available.

When present, the concentration of the organosilicon compound (B′) in the condensation-curable silicone composition is sufficient to cure (cross-link) the organopolysiloxane (A′). The particular amount of the organosilicon compound (B′) utilized depends on the desired extent of cure, which generally increases as the ratio of the number of moles of silicon-bonded hydrolysable groups in the organosilicon compound (B′) to the number of moles of silicon-bonded hydroxy groups in the organopolysiloxane (A′) increases. The optimum amount of the organosilicon compound (B′) can be readily determined by routine experimentation.

The condensation catalyst (C′) can be any condensation catalyst typically used to promote condensation of silicon-bonded hydroxy (silanol) groups to form Si—O—Si linkages. Examples of condensation catalysts include, but are not limited to, amines, complexes of metals (e.g. lead, tin, zinc, iron, titanium, zirconium) with organic ligands (e.g. carboxyl, hydrocarbyl, alkoxyl, etc.) In particular embodiments, the condensation catalyst (C′) can be selected from tin (II) and tin (IV) compounds such as tin dilaurate, tin dioctoate, dibutyltin dilaurate, dibutyltin diacetate, and tetrabutyl tin; and titanium compounds such as titanium tetrabutoxide. In these or other embodiments, the condensation catalyst (C′) may be selected from zinc-based, iron-based, and zirconium-based catalysts.

When present, the concentration of the condensation catalyst (C′) is typically from 0.1 to 10% (w/w), alternatively from 0.5 to 5% (w/w), alternatively from 1 to 3% (w/w), based on the total weight of the organopolysiloxane (A′) in the condensation-curable silicone composition.

When the condensation-curable silicone composition includes the condensation catalyst (C′), the condensation-curable silicone composition is typically a two-part composition where the organopolysiloxane (A′) and condensation catalyst (C′) are in separate parts. In this embodiment, the organosilicon compound (B′) is typically present along with the condensation catalyst (C′). Alternatively still, the condensation-curable silicone composition may be a three-part composition, where the organopolysiloxane (A′), the organosilicon compound (B′) and condensation catalyst (C′) are in separate parts.

Solidification conditions for such condensation-curable silicone compositions may vary. For example, condensation-curable silicone composition may be solidified or cured upon exposure to ambient conditions, a moisturized atmosphere, and/or heat, although heat is commonly utilized to accelerate solidification and curing.

In these or other embodiments, at least one of the silicone compositions comprises a free radical-curable silicone composition. In one embodiment, the free radical-curable silicone composition comprises (A″) an organopolysiloxane having an average of at least two silicon-bonded unsaturated groups and (C″) a free radical initiator.

The organopolysiloxane (A″) may be linear, branched, cyclic, or resinous. In particular, the organopolysiloxane (A″) may comprise any combination of M, D, T, and Q units, as with the organopolysiloxane (A′) and the organosilicon compound (B′) disclosed above.

The particular organopolysiloxane (A″) may be selected based on desired properties of the 3D article and layers during the method. For example, it may be desirable for the layers to be in the form of an elastomer, a gel, a resin, etc., and selecting the components of the silicone composition allows one of skill in the art to achieve a range of desirable properties.

For example, in certain embodiments, the organopolysiloxane (A″) comprises a silicone resin, which typically comprises T and/or Q units in combination with M and/or D units. When the organopolysiloxane (A″) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the hydrosilylation-curable silicone composition comprises a resin, the layer(s) and resulting 3D article have increased rigidity.

Alternatively, in other embodiments, the organopolysiloxane (A″) comprises repeating D units. Such organopolysiloxanes are substantially linear but may include some branching attributable to T and/or Q units. Alternatively, such organopolysiloxanes are linear. In these embodiments, the layer(s) and resulting 3D article are elastomeric.

The silicon-bonded unsaturated groups of the organopolysiloxane (A″) may be pendent, terminal, or in both positions. The silicon-bonded unsaturated groups may include ethylenic unsaturation in the form of double bonds and/or triple bonds. Exemplary examples of silicon-bonded unsaturated groups include silicon-bonded alkenyl groups and silicon-bonded alkynyl groups. The unsaturated groups may be bonded to silicon directly, or indirectly through a bridging group such as an alkylene group, an ether, an ester, an amide, or another group.

In a specific embodiment, the organopolysiloxane (A″) has the general formula:

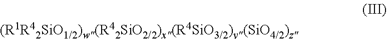

wherein each R¹ is defined above and each R⁴ is independently selected from R¹ and an unsaturated group, with the proviso that at least two of R⁴ are unsaturated groups, and w″, x″, y″, and z″ are mole fractions such that w″+x″+y″+z″=1. As understood in the art, for linear organopolysiloxanes, subscripts y″ and z″ are generally 0, whereas for resins, subscripts y″ and/or z″>0. Various alternative embodiments are described below with reference to w″, x″, y″ and z″. In these embodiments, the subscript w″ may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x″ typically has a value of from 0 to 0.999, alternatively from 0 to 0.45, alternatively from 0 to 0.25. The subscript y″ typically has a value of from 0 to 0.99, alternatively from 0.25 to 0.8, alternatively from 0.5 to 0.8. The subscript z″ typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

The unsaturated groups represented by R⁴ may be the same or different and are independently selected from alkenyl and alkynyl groups. The alkenyl groups represented by R⁴, which may be the same or different, are as defined and exemplified in the description of R² above. The alkynyl groups represented by R⁴, which may be the same or different, typically have from 2 to about 10 carbon atoms, alternatively from 2 to 8 carbon atoms, and are exemplified by, but are not limited to, ethynyl, propynyl, butynyl, hexynyl, and octynyl.

The free radical-curable silicone composition can further comprise an unsaturated compound selected from (i) at least one organosilicon compound having at least one silicon-bonded alkenyl group per molecule, (ii) at least one organic compound having at least one aliphatic carbon-carbon double bond per molecule, (iii) at least one organosilicon compound having at least one silicon-bonded acryloyl group per molecule; (iv) at least one organic compound having at least one acryloyl group per molecule; and (v) mixtures comprising (i), (ii), (iii) and (iv). The unsaturated compound can have a linear, branched, or cyclic structure.

The organosilicon compound (i) can be an organosilane or an organosiloxane. The organosilane can be a monosilane, disilane, trisilane, or polysilane. Similarly, the organosiloxane can be a disiloxane, trisiloxane, or polysiloxane. Cyclosilanes and cyclosiloxanes typically have from 3 to 12 silicon atoms, alternatively from 3 to 10 silicon atoms, alternatively from 3 to 4 silicon atoms. In acyclic polysilanes and polysiloxanes, the silicon-bonded alkenyl group(s) can be located at terminal, pendant, or at both terminal and pendant positions.

Specific examples of organosilanes include, but are not limited to, silanes having the following formulae:

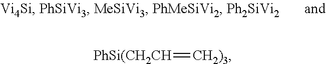

wherein Me is methyl, Ph is phenyl, and Vi is vinyl.

Specific examples of organosiloxanes include, but are not limited to, siloxanes having the following formulae:

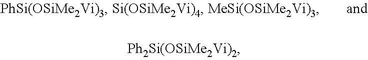

wherein Me is methyl, Vi is vinyl, and Ph is phenyl.

The organic compound can be any organic compound containing at least one aliphatic carbon-carbon double bond per molecule, provided the compound does not prevent the organopolysiloxane (A″) from curing to form a silicone resin film. The organic compound can be an alkene, a diene, a triene, or a polyene. Further, in acyclic organic compounds, the carbon-carbon double bond(s) can be located at terminal, pendant, or at both terminal and pendant positions.

The organic compound can contain one or more functional groups other than the aliphatic carbon-carbon double bond. Examples of suitable functional groups include, but are not limited to, —O—, >C═O, —CHO, —CO₂—, —C═N, —NO₂, >C=C<, —C═C—, —F, —Cl, —Br, and —I. The suitability of a particular unsaturated organic compound for use in the free-radical curable silicone composition can be readily determined by routine experimentation.

Examples of organic compounds containing aliphatic carbon-carbon double bonds include, but are not limited to, 1,4-divinylbenzene, 1,3-hexadienylbenzene, and 1,2-diethenylcyclobutane.

The unsaturated compound can be a single unsaturated compound or a mixture comprising two or more different unsaturated compounds, each as described above. For example, the unsaturated compound can be a single organosilane, a mixture of two different organosilanes, a single organosiloxane, a mixture of two different organosiloxanes, a mixture of an organosilane and an organosiloxane, a single organic compound, a mixture of two different organic compounds, a mixture of an organosilane and an organic compound, or a mixture of an organosiloxane and an organic compound.

The free radical initiator (C″) is a compound that produces a free radical, and is utilized to initiate polymerization of the organopolysiloxane (A″). Typically, the free radical initiator (C″) produces a free radical via dissociation caused by irradiation, heat, and/or reduction by a reducing agent. The free radical initiator (C″) may be an organic peroxide. Examples of organic peroxides include, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy) hexane; diaralkyl peroxides such as dicumyl peroxide; alkyl aralkyl peroxides such as t-butyl cumyl peroxide and 1,4-bis(t-butylperoxyisopropyl)benzene; and alkyl aryl peroxides such as t-butyl perbenzoate, t-butyl peracetate, and t-butyl peroctoate.

The organic peroxide (C″) can be a single peroxide or a mixture comprising two or more different organic peroxides. The concentration of the organic peroxide is typically from 0.1 to 5% (w/w), alternatively from 0.2 to 2% (w/w), based on the weight of the organopolysiloxane (A″).

The free radical-curable silicone composition may be a two-part composition where the organopolysiloxane (A″) and the free radical initiator (C″) are in separate parts.

In other embodiments, at least one of the silicone compositions comprises a ring opening reaction-curable silicone composition. In various embodiments, the ring opening reaction-curable silicone composition comprises (A′″) an organopolysiloxane having an average of at least two epoxy-substituted groups per molecule and (C′″) a curing agent. However, the ring opening reaction-curable silicone composition is not limited specifically to epoxy-functional organopolysiloxanes. Other examples of ring opening reaction-curable silicone compositions include those comprising silacyclobutane and/or benzocyclobutene.

The organopolysiloxane (A′″) may be linear, branched, cyclic, or resinous. In particular, the organopolysiloxane (A″) may comprise any combination of M, D, T, and Q units, as with the organopolysiloxane (A′) and the organosilicon compound (B′) disclosed above.

The particular organopolysiloxane (A″) may be selected based on desired properties of the 3D article and layers during the method. For example, it may be desirable for the layers to be in the form of an elastomer, a gel, a resin, etc., and selecting the components of the silicone composition allows one of skill in the art to achieve a range of desirable properties.

For example, in certain embodiments, the organopolysiloxane (A′″) comprises a silicone resin, which typically comprises T and/or Q units in combination with M and/or D units. When the organopolysiloxane (A′″) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the hydrosilylation-curable silicone composition comprises a resin, the layer(s) and resulting 3D article have increased rigidity.

Alternatively, in other embodiments, the organopolysiloxane (A′″) comprises repeating D units. Such organopolysiloxanes are substantially linear but may include some branching attributable to T and/or Q units. Alternatively, such organopolysiloxanes are linear. In these embodiments, the layer(s) and resulting 3D article are elastomeric.

The epoxy-substituted groups of the organopolysiloxane (A″) may be pendent, terminal, or in both positions. “Epoxy-substituted groups” are generally monovalent organic groups in which an oxygen atom, the epoxy substituent, is directly attached to two adjacent carbon atoms of a carbon chain or ring system. Examples of epoxy-substituted organic groups include, but are not limited to, 2,3-epoxypropyl, 3,4-epoxybutyl, 4,5-epoxypentyl, 2-glycidoxyethyl, 3-glycidoxypropyl, 4-glycidoxybutyl, 2-(3,4-epoxycylohexyl)ethyl, 3-(3,4-epoxycylohexyl) propyl, 2-(3,4-epoxy-3-methylcylohexyl)-2-methylethyl, 2-(2,3-epoxycylopentyl)ethyl, and 3-(2,3 epoxycylopentyl) propyl.

In a specific embodiment, the organopolysiloxane (A″) has the general formula:

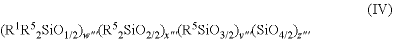

wherein each R¹ is defined above and each R⁵ is independently selected from R¹ and an epoxy-substituted group, with the proviso that at least two of R⁵ are epoxy-substituted groups, and w′″, x″, y′″, and z″′ are mole fractions such that w′″+x′″+y′″+z′″=1. As understood in the art, for linear organopolysiloxanes, subscripts y″′ and z′″ are generally 0, whereas for resins, subscripts y′″ and/or z′″>0. Various alternative embodiments are described below with reference to w′″, x′″, y′″ and z′″. In these embodiments, the subscript w′″ may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99, The subscript x′″ typically has a value of from 0 to 0.999, alternatively from 0 to 0.45, alternatively from 0 to 0.25. The subscript y′″ typically has a value of from 0 to 0.99, alternatively from 0.25 to 0.8, alternatively from 0.5 to 0.8. The subscript z′″ typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

The curing agent (C′″) can be any curing agent suitable for curing the organopolysiloxane (A′″). Examples of curing agents (C′″) suitable for that purpose include phenolic compounds, carboxylic acid compounds, acid anhydrides, amine compounds, compounds containing alkoxy groups, compounds containing hydroxyl groups, or mixtures thereof or partial reaction products thereof. More specifically, examples of curing agents (C′″) include tertiary amine compounds, such as imidazole; quaternary amine compounds; phosphorus compounds, such as phosphine; aluminum compounds, such as organic aluminum compounds; and zirconium compounds, such as organic zirconium compounds. Furthermore, either a curing agent or curing catalyst or a combination of a curing agent and a curing catalyst can be used as the curing agent (C′″). The curing agent (C′″) can also be a photoacid or photoacid generating compound.

The ratio of the curing agent (C′″) to the organopolysiloxane (A′″) is not limited. In certain embodiments, this ratio is from 0.1-500 parts by weight of the curing agent (C′″) per 100 parts by weight of the organopolysiloxane (A′″).

In other embodiments, at least one of the silicone compositions comprises a thiol-ene curable silicone composition. In these embodiments, the thiol-ene curable silicone composition typically comprises: (A′″″) an organopolysiloxane having an average of at least two silicon-bonded alkenyl groups or silicon-bonded mercapto-alkyl groups per molecule; (B′″″) an organosilicon compound having an average of at least two silicon-bonded mercapto-alkyl groups or silicon-bonded alkenyl groups per molecule capable of reacting with the silicon-bonded alkenyl groups or silicon-bonded mercapto-alkyl groups in the organopolysiloxane (A′″″); (C′″″) a catalyst; and (D′″″) an optional organic compound containing two or more mercapto groups. When the organopolysiloxane (A′″″) includes silicon-bonded alkenyl groups, the organosilicon compound (B′″″) and/or the organic compound (D′″″) include at least two mercapto groups per molecule bonded to the silicon and/or in the organic compound, and when the organopolysiloxane (A′″″) includes silicon-bonded mercapto groups, the organosilicon compound (B′″″) includes at least two silicon-bonded alkenyl groups per molecule. The organosilicon compound (B′″″) and/or the organic compound (D′″″) may be referred to as a cross-linker or cross-linking agent. The catalyst (C′″″) can be any catalyst suitable for catalyzing a reaction between the organopolysiloxane (A′″″) and the organosilicon compound (B′″″) and/or the organic compound (D′″″). Typically, the catalyst (C′″″) is selected from: i) a free radical catalyst; ii) a nucleophilic reagent; and iii) a combination of i) and ii). Suitable free radical catalysts for use as the catalyst (C′″″) include photo-activated free radical catalysts, heat-activated free radical catalysts, room temperature free radical catalysts such as redox catalysts and alkylborane catalysts, and combinations thereof. Suitable nucleophilic reagents for use as the catalyst (C′″″) include amines, phosphines, and combinations thereof.

In still other embodiments, at least one of the silicone compositions comprises a silicon hydride-silanol reaction curable silicone composition. In these embodiments, the silicon hydride-silanol reaction curable silicone composition typically comprises: (A″″″) an organopolysiloxane having an average of at least two silicon-bonded hydrogen atoms or at least two silicone bonded hydroxyl groups per molecule; (B″″″) an organosilicon compound having an average of at least two silicon-bonded hydroxyl groups or at least two silicon bonded hydrogen atoms per molecule capable of reacting with the silicon-bonded hydrogen atoms or silicon-bonded hydroxyl groups in the organopolysiloxane (A″″″); (C″″″) a catalyst; and (D″″″) an optional active hydrogen containing compound. When the organopolysiloxane (A″″″) includes silicon-bonded hydrogen atoms, the organosilicon compound (B″″″) and/or the organic compound (D″″″) include at least two hydroxyl groups per molecule bonded to the silicon and/or in the active hydrogen containing compound, and when the organopolysiloxane (A″″″) includes silicon-bonded hydroxyl groups, the organosilicon compound (B″″″) includes at least two silicon-bonded hydrogen atoms per molecule. The organosilicon compound (B″″″) and/or the organic compound (D″″″) may be referred to as a cross-linker or cross-linking agent.

Typically, the catalyst (C″″″) is selected from: i) a Group X metal-containing catalyst such as platinum; ii) a base such as metal hydroxide, amine, or phosphine; and iii) combinations thereof.

Solidification conditions for such silicon hydride-silanol condensation-curable silicone compositions may vary. Typically, such compositions are mixed as a two-part system and subsequently cured under ambient conditions. However, heat may also be utilized during solidification.

Any of the silicone compositions may optionally and independently further comprise additional ingredients or components, especially if the ingredient or component does not prevent the organosiloxane of the composition from curing. Examples of additional ingredients include, but are not limited to, fillers; inhibitors; adhesion promoters; dyes; pigments; anti-oxidants; carrier vehicles; heat stabilizers; flame retardants; thixotroping agents; flow control additives; fillers, including extending and reinforcing fillers; and cross-linking agents. In various embodiments, the composition further comprises ceramic powder. The amount of ceramic powder can vary and may depend on the 3D printing process being utilized.

One or more of the additives can be present as any suitable wt. % of the particular silicone composition, such as about 0.1 wt. % to about 15 wt. %, about 0.5 wt. % to about 5 wt. %, or about 0.1 wt. % or less, about 1 wt. %, 2, 3, 4, 5, 6, 7, 8, 9, 10, 11, 12, 13, 14, or about 15 wt. % or more of the silicone composition.

In certain embodiments, the silicone compositions are shear thinning. Compositions with shear thinning properties may be referred to as psuedoplastics. As understood in the art, compositions with shear thinning properties are characterized by having a viscosity which decreases upon an increased rate of shear strain. Said differently, viscosity and shear strain are inversely proportional for shear thinning compositions. When the silicone compositions are shear thinning, the silicone compositions are particularly well suited for printing, especially when a nozzle or other dispense mechanism is utilized. A specific example of a shear thinning silicone composition is XIAMETER® 9200 LSR, commercially available from Dow Silicones Corporation of Midland, MI.

In certain embodiments, at least one of the compositions, e.g. the substrate composition, the first composition, the second composition, and/or any subsequent or additional compositions, comprises the metal. The metal may be any of metal or alloy, and may be a liquid or slurry. Typically, a low-melting metal is used such that the at least one composition comprising the metal and/or the metal itself can be melted in an extruder and printed and/or deposited accordingly. In some embodiments, porous sections comprising the metal are formed during the printing process. Alternatively, sections comprising the metal which are not porous are formed during the printing process and may be incorporated as a section in the 3D article to add functionality (e.g. structural support, section separation, etc.). When the metal is a liquid, an appropriate solidification condition and/or mechanism is utilized. Such solidification conditions include sufficient cooling and forming a solid alloy with another material already presented on the substrate the liquid metal is being deposited onto. In some embodiments, the metal is a slurry of metal particles in a carrier such as water or a non-oxidizing solvent. The slurry can be printed into a porous section by itself, or as a nonporous section of an otherwise porous body. The printed section formed from slurry can be further processed, such as via laser melting, etching, and/or sintering.

In certain embodiments, at least one of the compositions, e.g. the first composition, the second composition, and/or any subsequent or additional compositions, comprises the slurry. In one embodiment, the slurry is a ceramic slurry. The ceramic slurry may be carried by water, and may be combined with one or more binders, such as one of the resins described above. Typically, the ceramic slurry can be dried/solidified via evaporation of the carrier (e.g. water) and/or drying. The dried/solidified ceramic slurry can be further processed or consolidated by heating, such as via convection, heat conduction, or radiation. Ceramics that may be used to form the ceramic slurry include oxides of various metals, carbides, nitrides, borides, silicides, and combinations and/or modifications thereof. In some embodiments, as mentioned above, the slurry is a metal slurry. In these or other embodiments, the slurry comprises, alternatively is a resin slurry. The resin slurry is typically a solution or dispersion of a resin in water or an organic solvent. The resin slurry may comprise any suitable resin, such as one of the resins described above, and typically comprises a viscosity suitable for printing at ambient or elevated temperatures.

Any of the compositions may optionally and independently further comprise additional ingredients or components, especially if the ingredient or component does not prevent any particular component of the composition from curing. Examples of additional ingredients include: inhibitors; adhesion promoters; dyes; pigments; anti-oxidants; carrier vehicles; heat stabilizers; flame retardants; thixotroping agents; flow control additives; fillers, including extending and reinforcing fillers; and cross-linking agents. In various embodiments, the composition further comprises ceramic powder. The amount of ceramic powder can vary and may depend on the 3D printing process being utilized.

Each of the additives can be present at any suitable wt. % of the particular composition, such as about 0.1 wt. % to about 15 wt. %, about 0.5 wt. % to about 5 wt. %, or about 0.1 wt. % or less, about 1 wt. %, 2, 3, 4, 5, 6, 7, 8, 9, 10, 11, 12, 13, 14, or about 15 wt. % or more of the particular composition.

In certain embodiments, the compositions are shear thinning. Compositions with shear thinning properties may be referred to as puedoplastics. As understood in the art, compositions with shear thinning properties are characterized by having a viscosity which decreases upon an increased rate of shear strain. Said differently, viscosity and shear strain are inversely proportional for shear thinning compositions. When the compositions are shear thinning, the compositions are particularly well suited for printing, especially when a nozzle or other dispense mechanism is utilized. A specific example of a shear-thinning composition comprising a silicone composition is XIAMETER® 9200 LSR, commercially available from Dow Silicones Corporation of Midland, MI.

Any of the compositions described above may be a single part or a multi-part composition, as described above with reference to certain silicone compositions. Certain compositions are highly reactive such that multi-part compositions prevent premature mixing and curing of the components. The multi-part composition may be, for example, a two-part system, a three-part system, etc. contingent on the selection of the composition and the components thereof. Any component of the composition may be separate from and individually controlled with respect to the remaining components.

In certain embodiments, when the compositions are multi-part compositions, the separate parts of the multi-part composition may be mixed in the shaft 214 of the additive manufacturing guide 200 or in the nozzle tip 104 of the additive manufacturing guide, e.g. a dual dispense printing nozzle, prior to and/or during printing. Alternatively, the separate parts may be combined immediately prior to printing. Alternatively still, the separate parts may be combined after exiting the additive manufacturing guide 200, e.g. by crossing printing streams or by mixing the separate parts as the layers are formed.

The compositions can be of various viscosities, such as any of the dynamic viscosities described above in relation to the first composition. In certain embodiments, the viscosity of the composition is further defined as a kinematic viscosity, and is less than 500, less than 250, or less than 100, centistokes (cSt) at 25° C., where 1 cSt=1 mm²·s⁻¹=10⁻⁶ m²·s⁻¹. In some embodiments, the composition comprises a kinematic viscosity of from 1 to 1,000,000, from 1 to 100,000, or from 1 to 10,000 cSt at 25° C. Viscosity of each composition can be changed by altering the amounts and/or molecular weight of one or more components thereof. Viscosity may be adjusted to match components of the nozzle or apparatus, particularly any nozzle or dispensing mechanism, to control heat, speed or other parameters associated with printing. As readily understood in the art, dynamic and/or kinematic viscosity may be measured in accordance with various methods and techniques, such as those set forth in ASTM D-445 (2011), titled “Standard Test Method for Kinematic Viscosity of Transparent and Opaque Liquids (and Calculation of Dynamic Viscosity);” ASTM D-7483 (2017), titled “Standard Test Method for Determination of Dynamic Viscosity and Derived Kinematic Viscosity of Liquids by Oscillating Piston Viscometer;” ASTM D-7945 (2016), titled “Standard Test Method for Determination of Dynamic Viscosity and Derived Kinematic Viscosity of Liquids by Constant Pressure Viscometer;” and/or ASTM D7042 (2016), titled “Standard Test Method for Dynamic Viscosity and Density of Liquids by Stabinger Viscometer (and the Calculation of Kinematic Viscosity);” and the like, as well as modifications and/or combinations thereof.

As will be appreciated from the disclosure herein, the compositions may be in any form suitable for printing and, subsequently, for solidification after printing. Accordingly, each composition utilized may independently be in a liquid, solid, or semi-solid form. For example, each composition may be utilized as a liquid suitable for forming streams and/or droplets, a powder, and/or a heat-meltable solid, depending on the particular composition and printing conditions selected and as described above.

As described above with respect to the first composition in particular, the elastic modulus of suitable examples of the composition is varied, and may change over time, e.g. due to curing, crosslinking, and/or hardening of the composition, including during the method. Typically, the elastic modulus of the composition is in the range of from 0.01 to 5000 MPa, such as from 0.1 to 150, from 0.1 to 125, from 0.2 to 100, from 0.2 to 90, from 0.2 to 80, from 0.3 to 80, from 0.3 to 70, from 0.3 to 60, from 0.3 to 50, from 0.3 to 45, from 0.4 to 40, or from 0.5 to 10 MPa. These ranges may apply to the elastic modulus of the composition at any time, such as before printing, during printing, and/or after printing. Moreover, more than one of such ranges may apply to the composition, e.g. when the elastic modulus of the composition changes over time (e.g. during and/or after printing). In certain embodiments, the composition has an elastic modulus of less than 120, alternatively less than 110, alternatively less than 100, alternatively less than 90, alternatively less than 80, alternatively less than 70, alternatively less than 60, alternatively less than 50, alternatively less than 40, alternatively less than 30 MPa during printing. As readily understood in the art, elastic modulus may be measured in accordance with various methods and techniques, such as those set forth in ASTM D638 (2014), titled “Standard Test Method for Tensile Properties of Plastics,” and the like, as well as via modifications and/or combinations thereof.

When the solidification condition comprising heating, exposure to the solidification condition typically comprises heating the layer(s) at an elevated temperature for a period of time. The elevated temperature and the period of time may vary based on numerous factors, including the selection of the particular silicone composition, a desired cross-link density of the at least partially solidified layer, dimensions of the layer(s), etc. In certain embodiments, the elevated temperature is from above room temperature to 500, alternatively from 30 to 450, alternatively from 30 to 350, alternatively from 30 to 300, alternatively from 30 to 250, alternatively from 40 to 200, alternatively from 50 to 150,° C. In these or other embodiments, the period of time is from 0.001 to 600, alternatively from 0.04 to 60, alternatively from 0.1 to 10, alternatively from 0.1 to 5, alternatively from 0.2 to 2, minutes.

Any source of heat may be utilized for exposing the layer(s) to heat. For example, the source of heat may be a convection oven, rapid thermal processing, a hot bath, a hot plate, or radiant heat. Further, if desired, a heat mask or other similar device may be utilized for selective curing of the layer(s), as introduced above.

In certain embodiments, heating is selected from (i) conductive heating via a substrate on which the layer is printed; (ii) heating the silicone composition via the 3D printer or a component thereof; (iii) infrared heating; (iv) radio frequency or micro-wave heating; (v) a heating bath with a heat transfer fluid; (vi) heating from an exothermic reaction of the silicone composition; (vii) magnetic heating; (viii) oscillating electric field heating; and (ix) combinations thereof. When the method includes more than one heating step, e.g. in connection with each individual layer, each heating step is independently selected.

Such heating techniques are known in the art. For example, the heat transfer fluid is generally an inert fluid, e.g. water, which may surround and contact the layer as the silicone composition is printed, thus initiating at least partial curing thereof. With respect to (ii) heating the silicone composition via the 3D printer or a component thereof, any portion of the silicone composition may be heated and combined with the remaining portion, or the silicone composition may be heated in its entirety. For example, a portion (e.g. one component) of the silicone composition may be heated, and, once combined with the remaining portion, the silicone composition initiates curing. The combination of the heated portion and remaining portion may be before, during, and/or after the step of printing the silicone composition. The components may be separately printed.

Alternatively or in addition, the solidification condition may be exposure to irradiation.

The energy source independently utilized for the irradiation may emit various wavelengths across the electromagnetic spectrum. In various embodiments, the energy source emits at least one of ultraviolet (UV) radiation, microwave radiation, radiofrequency radiation, infrared (IR) radiation, visible light, X-rays, gamma rays, oscillating electric field, or electron beams (e-beam). One or more energy sources may be utilized.

In certain embodiments, the energy source emits at least UV radiation. In physics, UV radiation is traditionally divided into four regions: near (400-300 nm), middle (300-200 nm), far (200-100 nm), and extreme (below 100 nm). In biology, three conventional divisions have been observed for UV radiation: near (400-315 nm); actinic (315-200 nm); and vacuum (less than 200 nm). In specific embodiments, the energy source emits UV radiation, alternatively actinic radiation. The terms of UVA, UVB, and UVC are also common in industry to describe the different wavelength ranges of UV radiation.

In certain embodiments, the radiation utilized to cure the layer(s) may have wavelengths outside of the UV range. For example, visible light having a wavelength of from 400 nm to 800 nm can be used. As another example, IR radiation having a wavelength beyond 800 nm can be used.

In other embodiments, an e-beam can be utilized to cure the layer(s). In these embodiments, the accelerating voltage can be from about 0.1 to about 10 MeV, the vacuum can be from about 10 to about 10⁻³ Pa, the electron current can be from about 0.0001 to about 1 ampere, and the power can vary from about 0.1 watt to about 1 kilowatt. The dose is typically from about 100 micro-coulomb/cm² to about 100 coulomb/cm², alternatively from about 1 to about 10 coulombs/cm². Depending on the voltage, the time of exposure is typically from about 10 seconds to 1 hour; however, shorter or longer exposure times may also be utilized.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

A 3D article printed using the method or apparatus is The 3D article formed in accordance to the method is not limited, and may be any 3D article formable using an AM process suitable for practicing the method of this disclosure. Typically, the 3D article comprises flexible components and/or thin walls, such as those formed using the deformable compositions of this disclosure. For example, in certain embodiments the 3D article is a pneumatic actuator that is may bend, move, or otherwise flex in response to a pneumatic force (e.g. air pressure) being applied thereto. In these or other embodiments, the 3D article is a biological (e.g. medical and/or dental) device. In such embodiments, the 3D article may advantageously be formed using the flexible silicone compositions of this disclosure, e.g. due to their high biocompatibility. Example of such medical devices include prostheses, tubing (e.g. feeding tubes), drains, catheters, implants (e.g. long-term and/or short term), seals, gaskets, syringe pistons, dental guards, etc.

### REFERENCE NUMERALS

Additive manufacturing guide 100
Radial actuator 102
Nozzle tip 104
Variable area outlet aperture 106
Toric housing 108
Toric balloon 110
Fluid inlet arms 112
Fluid inlet 114
Fluid nozzle 116
Elastomeric body 118
Metal rods 120
Outlet cone 122
Cylindrical inlet 124
Feedstock nozzle 126
Radial actuator seat 128
Nozzle seating 130
Radial actuator seat fastening aperture 132
Mount fastening aperture 134
Nozzle seat fastening aperture 136
Mount 138
Toric chamber 140
Nozzle aperture 142
Deformation sensor 144
Additive manufacturing guide 200
Linear actuator 202
Deformable membrane 204
Variable area outlet aperture 206
Membrane support 208
Membrane aperture 210
Actuator arms 212
Shaft 214
Through space 216
Curved tip 218
Printing outlet 220
Guide housing 222
Storage tank 224
Rod axis RA
Central axis CA

What is claimed is:

1. An additive manufacturing guide for variable size additive manufacturing, the additive manufacturing guide comprising:
a. an actuator movable between a maximum flow position and a minimum flow position; and
b. an adjustable port defining a variable area outlet aperture, the actuator configured to deform the adjustable port to selectively resize the variable area outlet aperture; and
c. wherein the maximum flow position corresponds to a maximum area of the variable area outlet aperture and the minimum flow position corresponds to a minimum area of the variable area outlet aperture.

2. The additive manufacturing guide of claim 1, wherein the variable area outlet aperture defines a circular cross-section.

3. The additive manufacturing guide of claim 1, wherein the minimum flow position corresponds to a closed variable area outlet aperture having a minimum area of zero.

4. The additive manufacturing guide of claim 1, wherein:
a. the actuator is a pneumatic radial actuator comprising a toric housing and a toric balloon disposed therein, wherein inflation or deflation of the toric ballon displaces the toric housing and increases or decreases a volume of the toric housing;
b. the adjustable port is a nozzle tip comprising a conical elastomeric body embedded with a network of metal rods; and
c. wherein the toric housing of the pneumatic radial actuator is disposed about the conical elastomer body of the nozzle tip such that inflation of the toric ballon compresses the network of metal rods and shrinks the variable area outlet aperture and deflation of the toric ballon relaxes the network of metal rods and enlarges the variable area outlet aperture.

5. The additive manufacturing guide of claim 4 further comprising a deformation sensor comprising a series of electrically conductive wire coil disposed about an outer surface of the nozzle tip.

6. The additive manufacturing guide of claim 4, wherein each metal rod defines a rod axis, the network of metal rods are symmetrically disposed about a central axis, and each rod axis defines a non-right angle with the central axis.

7. The additive manufacturing guide of claim 1, wherein:
a. the actuator is a linear actuator coupled to a membrane support defining a membrane aperture; and
b. the adjustable port is a deformable membrane coupled to the membrane support such that the membrane aperture and the variable area outlet aperture are aligned.

8. The additive manufacturing guide of claim 7 further comprising:
a. a shaft defining a through space and comprising a curved tip contacting the deformable membrane and defining a printing outlet disposed proximate the variable area outlet aperture; and
b, wherein the movement of the linear actuator stretches or relaxes the deformable membrane about the curved tip of the shaft to enlarge or shrink the variable area outlet aperture.

9. The additive manufacturing guide of claim 7, wherein the linear actuator comprises a pair of actuator arms coupled to opposite ends of the membrane support.

10. An additive manufacturing system comprising the additive manufacturing guide of claim 1.

11. A method of additive manufacturing with variable bead sizes using the additive manufacturing guide of claim 4, the method comprising:
a. extruding a printing material out of the variable area outlet aperture defining a first area to form a first bead path having a first bead path width;
b. inflating or deflating the toric ballon to compress or relax the network of metal rods of the nozzle tip and shrink or enlarge the variable area outlet aperture to define a second area;
c. extruding the printing material out of the variable area outlet defining the second area to form a second bead path having a second bead path width; and
d. wherein the second area is smaller or larger than the first area, and the second bead path width is smaller or larger than the first bead path width.

12. The method of claim 11 further comprising:
a. measuring the power required to maintain the variable area outlet aperture at the first area or the second area against a force of the printing material acting on the nozzle tip;
b. calculating the force of the printing material acting on the nozzle tip from the power required to maintain the variable area outlet aperture at the first area or the second area;
c. calculating a fluid flow rate of the printing material from the force of the printing material acting on the nozzle tip; and
d. inflating or deflating the toric ballon to compress or relax the network of metal rods of the nozzle tip and shrink or enlarge the variable area outlet aperture to adjust the fluid flow rate to a target fluid flow rate.

13. A method of additive manufacturing with variable bead sizes using the additive manufacturing guide of claim 7, the method comprising:
a. extruding a printing material out of the variable area outlet aperture defining a first area to form a first bead path having a first bead path width;
b. linearly displacing the linear actuator from a first position to a second position to stretch or relax the deformable membrane about the curved tip of the shaft to enlarge or shrink the variable area outlet aperture to define a second area; and
c. extruding the printing material out of the variable area outlet defining the second area to form a second bead path having a second bead path width;
d. wherein the second area is smaller or larger than the first area, and the second bead path width is smaller or larger than the first bead path width.

14. The method of claim 13 further comprising:
a. measuring the power required to maintain the variable area outlet aperture at the first area or the second area against a force of the printing material acting on the deformable membrane;
b. calculating the force of the printing material acting on the deformable membrane from the power required to maintain the variable area outlet aperture at the first area or the second area;
c. calculating a fluid flow rate of the printing material from the force of the printing material acting on the deformable membrane; and
d. linearly displacing the linear actuator from a first position to a second position to stretch or relax the deformable membrane about the curved tip of the shaft to enlarge or shrink the variable area outlet aperture to adjust the fluid flow rate to a target fluid flow rate.
